(19) United States
(12) Patent Application Publication
(10) Pub. No.: US 2012/0243828 A1
(43) Pub. Date: Sep. 27, 2012

(54) RING OPTICAL MODULATOR

(75) Inventor: Nobuo SUZUKI, Kanagawa (JP)

(73) Assignee: KABUSHIKI KAISHA TOSHIBA, Tokyo (JP)

(21) Appl. No.: 13/242,584

(22) Filed: Sep. 23, 2011

(30) Foreign Application Priority Data
Mar. 23, 2011 (JP) 2011-064066

(51) Int. Cl. G02B 6/42

(52) U.S. Cl. 385/32

(57) ABSTRACT

A ring optical modulator according to an embodiment, includes a ring resonator and an input/output optical waveguide. The ring resonator is configured to have a closed loop optical waveguide in a p-i-n diode structure. A portion of the closed loop optical waveguide and a portion of the input/output optical waveguide positioned close to each other function as an optical coupler. Relationships of Formula (2) to Formula (8) are satisfied by a loss x [%] per revolution of the resonator when the current is turned off and a power coupling ratio y [%] of the optical coupler for the light of the resonant wavelength λᵣ revolving around the ring resonator from output to input of the optical coupler.

### CROSS-REFERENCE TO RELATED APPLICATION

This application is based upon and claims the benefit of priority from Japanese Patent Application No. 2011-064066 filed on Mar. 23, 2011 in Japan, the entire contents of which are incorporated herein by reference.

### FIELD

Embodiments described herein relate generally to a ring optical modulator.

### BACKGROUND

In recent years, miniaturization of optical elements is in progress by using a silicon (Si) photonic wire waveguide having a high refractive index contrast between a core and surroundings thereof. The typical sectional dimensions of a Si photonic wire waveguide in a 1.55-μm wavelength band are 220 nm×450 nm and a radiation loss of even a curved waveguide with a small curvature radius can be minimized by strong optical confinement based on a large difference of refractive indexes. Optical integrated circuits, in which a large number of fine optical/electronic devices are integrated, can be mass-produced by applying a highly developed CMOS process technology and thus, the application thereof not only to inter-device/inter-board optical interconnection, but also to inter-chip/intra-chip large-capacity optical wirings using WDM (wavelength division multiplexing) technology can be expected.

For the use thereof in optical interconnection or optical wiring, a transmitting function and a receiving function of an optical signal are at least needed. If the application to inter-chip/intra-chip optical wiring is considered, miniaturization of elements, reduction of power consumption (higher efficiency), and high-speed operation are important. On the receiving side, efficiency of around 1 mA/mW and the bandwidth of several to several tens of GHz have been realized by a waveguide Ge photodetector or InGaAs photodetector integrated with a Si photonic wire waveguide and having a length of 5 to 10 μm and a width of several μm.

On the transmitting side, it is extremely difficult to realize a high-efficiency laser with Si, which is an indirect transition semiconductor, and thus, an external light source and a Si optical modulator are generally combined. Si optical modulators include electroabsorption modulators, Mach-Zehnder optical modulators, and ring optical modulators, but a subminiature (footprint ≦100 μm²) optical modulator that can be applied to a large-capacity optical wiring on a chip is the ring optical modulator only.

The ring optical modulator is formed by at least one input/output optical waveguide and at least one ring resonator being coupled by an optical coupler and the resonant wavelength is changed by changing the carrier density of the optical waveguide constituting the ring resonator via the refractive index. Optical output power can be modulated by changing the resonant wavelength so as to the wavelength of incident light being switched between a state of being in a resonant band and a state of being outside the resonant band.

A change Δn in the refractive index of a Si waveguide caused by the carrier density can be approximated, as is already known, by Formula (1) shown below:

Δn=aₑNₑ+aₕNₕ^{0.8} (1)

Here, Nₑ is an electron density and Nₕ is a hole density. Coefficients aₑ, aₕ are quantities proportional to the square of a wavelength and have values aₑ=−8.8×10⁻²² cm³ and aₕ=−8.5×10⁻¹⁸ cm^{2.4} when the wavelength is 1.55 μm.

Methods of changing the carrier density can be classified into the following three categories:

(ii-a) Capacitor type sandwiching a thin dielectric film between two semiconductor layers
(ii-b) Depletion by applying a backward voltage to the optical waveguide in a pn diode structure
(ii-c) Carrier injection by passing a forward current to the optical waveguide in a pin diode structure

Optical modulators of the capacitor type in (ii-a) and the depletion mode in (ii-b) are fast, but efficiency of modulation is low and the amplitude of modulation voltage is higher. To improve the modulation efficiency, impurity distribution should be optimized to maximize the overlap of the guided wave mode and the region in which the carrier density changes, which reduces process margin compared with the carrier injection type of the pin structure in (ii-c). On the other hand, with an optical modulator of the carrier injection type in (ii-c), an extinction ratio of 10 dB or more can be obtained with a current change of several mA (voltage change of about 0.1 V) at a low frequency, but the response is slow because it takes time to inject carriers into the optical waveguide and eject carriers from the optical waveguide (up to 1 ns).

Pre-emphasis is known as a method of driving a carrier injection-type Si optical modulator with a p-i-n diode structure at a speed on the order of 10 Gbps. A pre-emphasized drive waveform can be created by amplifying and superimposing a differential waveform of an original drive waveform on the original drive waveform. Carrier injection and ejection inside the intrinsic (i)-Si region are accelerated by pre-emphasis when the on/off-states are switched so that a fast response output waveform can be obtained.

Currently, the upper limit of the modulation speed of a carrier injection-type ring optical modulator without pre-emphasis remains at 4 Gbps (amplitude 1.4 V), and the pre-emphasis has been the only method allowing the carrier injection-type ring optical modulator to operate at a high speed (e.g. 10 Gbps). However, pre-emphasis has a problem of a larger amplitude of modulation voltage and higher power consumption. Pre-emphasis also has a problem that a dedicated drive circuit is needed. Further, pre-emphasis has a problem that the heat generation is large and the operation thereof is more likely to be unstable due to the temperature-dependent resonance characteristics. Pre-emphasis has these disadvantages, which hinder commercialization of ring optical modulators. Particularly, a carrier injection-type ring optical modulator with a p-i-n diode structure has, as described above, a problem that it does not operate at a high speed unless large pre-emphasis is applied.

### BRIEF DESCRIPTION OF THE DRAWINGS

FIG. 1 shows a top view showing an example of the configuration of a ring optical modulator according to a first embodiment;

FIG. 2 is a sectional view showing an example of the configuration of a ring resonator portion according to the first embodiment;

FIG. 3 is a sectional view showing an example of the configuration of an optical coupler portion according to the first embodiment;

FIG. 4 is a diagram showing an example of the relationship between a distance from a mesa portion sidewall to a p+ region and an n+ region and an optical propagation loss by free carrier absorption;

FIG. 5 is a diagram showing changes of a transmission spectrum near the wavelength 1549 nm of the ring optical modulator according to the first embodiment by voltage application;

FIG. 6 is a diagram showing DC voltage-optical output characteristics at a wavelength of 1549.59 nm of the ring optical modulator according to the first embodiment;

FIG. 7 is a diagram showing simulation results of a modulated optical waveform at an output port of an input/output optical waveguide according to the first embodiment;

FIG. 8 is a diagram showing an eye pattern after an optical signal modulated by the ring optical modulator according to the first embodiment is received/equalized by an optical receiver optimized for 10-Gbps transmission;

FIG. 9 is a diagram showing the relationship between an optical receiver input level and a bit error rate (BER);

FIG. 10 is a top view showing another example of the configuration of the ring optical modulator according to the first embodiment;

FIGS. 11A and 11B are diagrams showing an example of simulation results of an optical modulated output waveform from the ring optical modulator in a circular shape and an example of the eye pattern after reception/equalization according to the first embodiment;

FIGS. 12A and 12B are diagrams showing an example of simulation results of an optical modulated output waveform when the distance between a mesa portion and a high-density region is increased in the ring optical modulator having a racetrack resonator and an example of the eye pattern after reception/equalization according to the first embodiment;

FIGS. 13A and 13B are diagrams showing an example of simulation results of the modulated optical waveform when the distance between the mesa portion and the high-density region is decreased in the ring optical modulator having the racetrack resonator and an example of the eye pattern after reception/equalization according to the first embodiment;

FIGS. 14A and 14B are diagrams showing light receiving characteristics when a circular loss of the resonator and a power coupling ratio of the optical coupler according to the first embodiment are allocated in a matrix form;

FIG. 15 is a flow chart showing principal processes of a method for fabricating the ring optical modulator according to the first embodiment;

FIGS. 16A to 16D are process sectional views of the ring optical modulator according to the first embodiment;

FIGS. 17A to 17D are diagrams showing evaluation results of transmission characteristics when the circular loss of the resonator and the power coupling ratio of the optical coupler according to a second embodiment are changed;

FIGS. 18A and 18B are diagrams showing an example of the shape of the ring resonator according to the second embodiment;

FIG. 19 is a sectional view showing an example of the configuration of a ring resonator portion of the ring optical modulator according to a third embodiment;

FIG. 20 is a sectional view showing an example of the configuration of the ring resonator portion of the ring optical modulator according to a fourth embodiment;

FIG. 21 is a sectional view showing an example of the configuration of a semiconductor device mounted with the ring optical modulator according to a fifth embodiment;

FIG. 22 is a conceptual diagram of a top surface showing the configuration of the ring optical modulator according to a sixth embodiment; and

FIG. 23 is a sectional view of the ring resonator portion of the ring optical modulator according to the sixth embodiment.

### DETAILED DESCRIPTION

A ring optical modulator according to an embodiment, includes a ring resonator and an input/output optical waveguide. The ring resonator is configured to have a closed loop optical waveguide in a p-i-n diode structure including a current injection portion injecting a current. The input/output optical waveguide is configured to input and output a light, and to be arranged in such a way that a portion thereof is positioned close to a portion of the closed loop optical waveguide. The portion of the closed loop optical waveguide and the portion of the input/output optical waveguide positioned close to each other function as an optical coupler, optically coupling the ring resonator and the input/output optical waveguide in the ring optical modulator. The ring resonator has some resonant wavelengths. Intensity of light set near one of the resonant wavelengths λᵣ input from one end of the input/output optical waveguide is modulated by changing a current injected into the ring resonator to change the resonant wavelength λᵣ via a carrier density and an effective refractive index in the closed loop optical waveguide. Further, Relationships of Formula (2) to Formula (8), using a group index n_{g} of refraction at the resonant wavelength λᵣ of the closed loop optical waveguide constituting the ring resonator, a circumference l [μm] of the closed loop optical waveguide, and a waveguide length l′ [μm] of a remaining portion of the closed loop optical waveguide excluding the portion of the ring resonator functioning as the optical coupler, are satisfied by a loss x [%] per round of the resonator for the light of a resonant wavelength λᵣ traveling around the ring resonator from output to input of the optical coupler when the current is turned off and a power coupling ratio y [%] of the optical coupler for the light of the resonant wavelength λᵣ.

$$\begin{matrix}x \geq \{ \begin{matrix}\frac{1}{{a}_{1}^{2}} {( y - {y}_{1} )}^{2} + {x}_{1} & ( y \geq {y}_{1} ) \\ {x}_{1} & ( y < {y}_{1} )\end{matrix} & ( 2 ) \\ y \geq \{ \begin{matrix}{{a}_{2} ( x - {x}_{2} )}^{2} + {y}_{2} & ( x \geq {x}_{2} ) \\ {y}_{2} & ( x < {x}_{2} )\end{matrix} & ( 3 ) \\ x \leq \{ \begin{matrix}{x}_{ma x} & ( y \leq {y}_{ma x} - 0.8 ) \\ {x}_{m ax} - ( y - {y}_{ma x} + 0.8 ) & ( y > {y}_{ma x} - 0.8 )\end{matrix} & ( 4 ) \\ y \leq {y}_{m ax} & ( 5 ) \\ {a}_{1} = 0.0034 {n}_{g} l + 2.96 \\ {x}_{1} = 0.0088 {n}_{g} l - 0.25 \\ {y}_{1} = 0.00118 {n}_{g} l - 1.45 & ( 6 ) \\ {a}_{2} = 0.27 \\ {x}_{2} = 0.0167 {n}_{g} l - 0.84 \\ {y}_{2} = 0.0091 {n}_{g} l & ( 7 ) \\ {x}_{ma x} = 0.0192 {n}_{g} {l}^{′} + 0.15 \\ {y}_{ma x} = 0.0211 {n}_{g} {l}^{′} + 0.58 & ( 8 )\end{matrix}$$

In the embodiments below, ring optical modulators capable of performing fast (up to 10 Gbps) modulation with still reduced modulation voltage amplitude (<1 V) will be described.

### First Embodiment

The first embodiment will be described below using drawings.

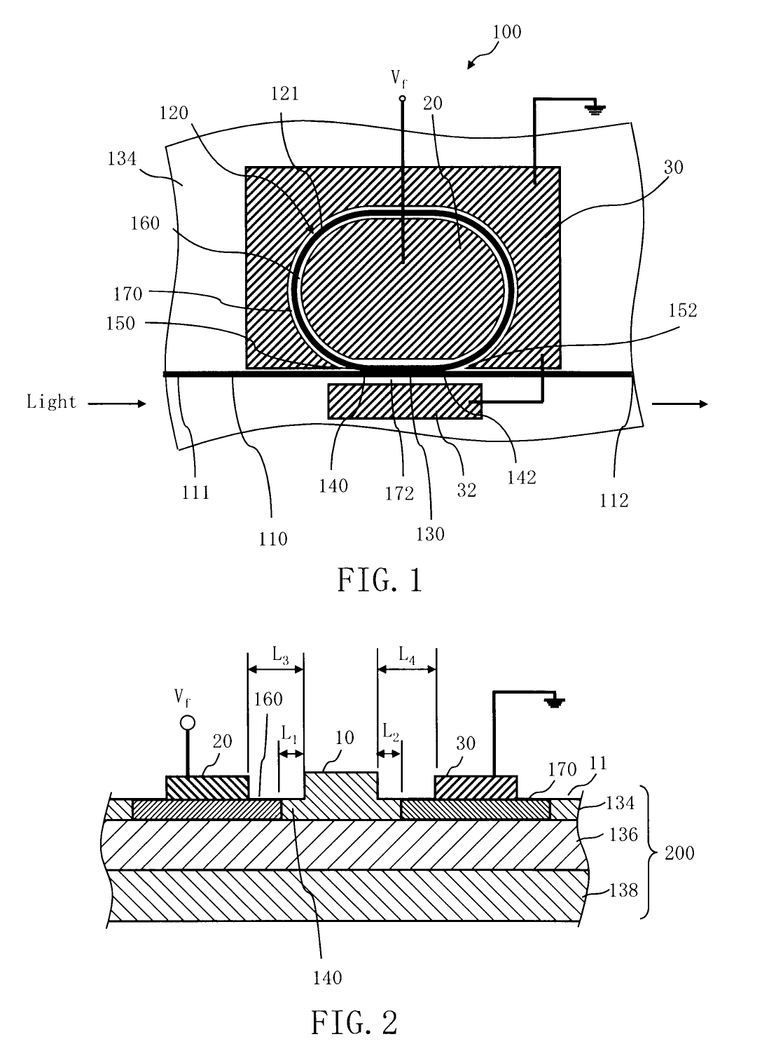

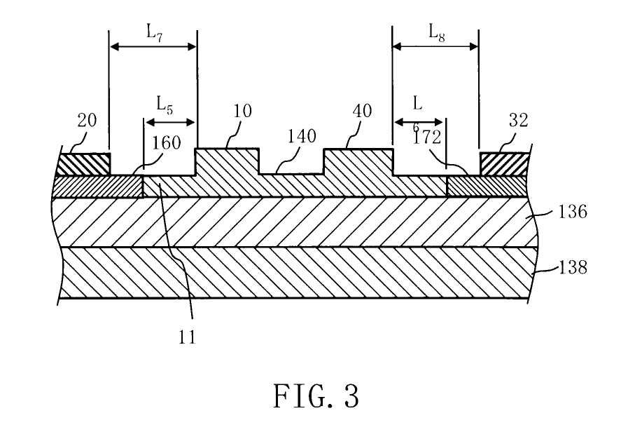

In FIG. 1, a top view showing an example of the configuration of a ring optical modulator according to the first embodiment is shown. In FIG. 2, a sectional view showing an example of the configuration of a ring resonator portion according to the first embodiment is shown. In FIG. 3, a sectional view showing an example of the configuration of an optical coupler portion according to the first embodiment is shown.

In FIG. 1, a ring optical modulator 100 includes a ring resonator 120 and an input/output optical waveguide 110. The ring resonator 120 has a closed loop optical waveguide 121 in a p-i-n diode structure including a current injection portion. The closed loop optical waveguide 121 is formed, as an example, in a racetrack shape composed of two parallel straight lines and semicircular portions connected to the two straight lines from left and right. In other words, the ring resonator 120 in FIG. 1 becomes a racetrack resonator. The input/output optical waveguide 110 is arranged in parallel with a straight line portion of the closed loop optical waveguide 121. Then, the input/output optical waveguide 110 is arranged in such a way that a portion thereof is positioned close to a portion of the closed loop optical waveguide 121. The portion of the closed loop optical waveguide 121 and the portion of the input/output optical waveguide 110 positioned close to each other function as an optical coupler 130 optically coupling the ring resonator 120 and the input/output optical waveguide 110. The ring optical modulator 100 modulates intensity of light set near one of the resonant wavelengths λᵣ input from one end of the input/output optical waveguide 110 by changing the current injected into the ring resonator 120 to change the predetermined resonant wavelength λᵣ via the carrier density and effective refractive index in the closed loop optical waveguide 121.

For example, a (p+) semiconductor region 160 (an example of impurity doped region) is formed inside the closed loop optical waveguide 121. Then, for example, an (n+) semiconductor region 170 (an example of impurity doped region) is formed outside the closed loop optical waveguide 121. An electrode 20 is formed on the (p+) semiconductor region 160. On the other hand, an electrode 30 is formed on the (n+) semiconductor region 170. Also, an (n+) semiconductor region 172 is formed on the side of the input/output optical waveguide 110 of the optical coupler 130. An electrode 32 is formed on the (n+) semiconductor region 172. The electrode 20 has a voltage V_{f} arranged to be applicable thereto. The electrodes 30 and 32 are electrically connected and grounded. The input light wavelength is set within one of the resonant wavelength bands when the applied voltage is lower than the turn-on voltage Vₒₙ of the diode (V_{f}=V_{L}<Vₒₙ). Since most of the light is trapped by the ring resonator, the output power is very small. When the applied voltage is raised to V_{f}=V_{H} (>Vₒₙ), the resonant wavelength λᵣ is shifted to a shorter wavelength by the injected carriers. Therefore, the input light gets out of the resonant wavelength band, and transmitted to the output port.

In the example in FIG. 1, the input/output optical waveguide 110 and the ring resonator 120 (closed loop optical waveguide 121) are coupled by a directional coupler (optical coupler 130) composed of a parallel waveguide whose length is 5 μm. A curvature radius R of a curved portion of the closed loop optical waveguide 121 is set to 10 μm and the width of a gap between the input/output optical waveguide 110 and the closed loop optical waveguide 121 in the optical coupler 130 is set to 380 nm.

The ring optical modulator 100 is suitably formed on, for example, an SOI (silicon on insulator) substrate, in which a Si substrate 138, a silicon oxide layer (SiO₂ layer) 136, and a top Si layer 134 are stacked. For example, the SiO₂ layer 136 is formed to a thickness of 3 μm to become a lower cladding part of the optical waveguide. The top Si layer 134 becomes a core of the optical waveguide. Excluding a mesa portion 40 to be a core of the input/output optical waveguide 110 and a mesa portion 10 to be a core of the closed loop optical waveguide 121, the Si layer 134 has been etched by dry etching. Here, the mesa portions 10, 40 are formed to a width of 450 nm and the mesa portions 10, 40 are formed to a thickness of 220 nm. A remaining slab portion 11 is formed to a thickness of 50 nm. Also, the mesa portions 10, 40 of the Si layer 134 are of p type with an acceptor density <1×10¹⁶ cm⁻³ (i (intrinsic)-Si region).

In this manner, a rib optical waveguide including mesa portions and slab portions positioned on both sides of the mesa portion is used as an optical waveguide constituting the ring resonator 120 and the input/output optical waveguide 110. Light propagates through the so-called rib optical waveguide. Because both the closed loop optical waveguide 121 and the input/output optical waveguide 110 are rib optical waveguides composed of mesa portions and slab portions having Si as a main component, the injection of current into the optical waveguide is made easier and also efficiency of modulation can be enhanced.

As shown in FIG. 2, the semiconductor region 160 of (p+) type (p type high impurity density region) whose carrier density is 5×10¹⁹ cm⁻³ or more is provided in one of the slab portions positioned on both sides of the mesa portion 10. The semiconductor region 170 of (n+) type (n type high impurity density region) whose carrier density is 5×10¹⁹ cm⁻³ or more is provided in the other slab portion. A region between the semiconductor region 160 of (p+) type and the semiconductor region 170 of (n+) type including the mesa portion 10 becomes an i-Si region 140 of a p-i-n diode structure. Thus, the closed loop optical waveguide 121 becomes the p-i-n diode structure including current injection portions such as the semiconductor regions 160, 170.

Also in an optical coupler 130 portion, as shown in FIG. 3, the mesa portions 10, 40 are arranged with a gap of the i-Si region 140. The above-mentioned semiconductor region 160 of (p+) type is formed in the slab portion 11 inside the closed loop optical waveguide 121. Then, the semiconductor region 172 of (n+) type is formed in the slab portion 11 on the opposite side of the mesa portions 10,40. Like the semiconductor region 170 of (n+) type, the semiconductor region 172 (n type high impurity density region) of (n+) type suitably has the carrier density of 5×10¹⁹ cm⁻³ or more.

In the first embodiment, it is found that fast (up to 10 Gbps) modulation can be performed with reduced modulation voltage amplitude (V_{H}−V_{L}<1 V) by configuring the ring optical modulator 100 so that the following relationships are satisfied. Accordingly, a miniature carrier injection ring optical modulator with low power consumption can be realized.

The group index of refraction at the resonant wavelength λᵣ of the closed loop optical waveguide 121 constituting the ring resonator 120 is set as n_{g}, the circumference of the closed loop optical waveguide 121 is set as l [μm], and the waveguide length of a remaining portion excluding a portion of the ring resonator 120 functioning as the optical coupler 130 of the closed loop optical waveguide 121 is set as l′ [μm]. In this case, relationships from Formula (2) to Formula (8) shown below may be satisfied by a loss x [%] per round of the resonator for light of the resonant wavelength λᵣ traveling around the ring resonator 120 from output 142 to input 140 of the optical coupler 130 when the current is turned off and a power coupling ratio y [%] of the optical coupler for light of the resonant wavelength λᵣ.

$$\begin{matrix}x \geq \{ \begin{matrix}\frac{1}{{a}_{1}^{2}} {( y - {y}_{1} )}^{2} + {x}_{1} & ( y \geq {y}_{1} ) \\ {x}_{1} & ( y < {y}_{1} )\end{matrix} & ( 2 ) \\ y \geq \{ \begin{matrix}{{a}_{2} ( x - {x}_{2} )}^{2} + {y}_{2} & ( x \geq {x}_{2} ) \\ {y}_{2} & ( x < {x}_{2} )\end{matrix} & ( 3 ) \\ x \leq \{ \begin{matrix}{x}_{ma x} & ( y \leq {y}_{ma x } - 0.8 ) \\ {x}_{ma x} - ( y - {y}_{ma x} + 0.8 ) & ( y > {y}_{ma x} - 0.8 )\end{matrix} & ( 4 ) \\ y \leq {y}_{ma x} & ( 5 ) \\ {a}_{1} = 0.0034 {n}_{g} l + 2.96 \\ {x}_{1} = 0.0088 {n}_{g} l - 0.25 \\ {y}_{1} = 0.00118 {n}_{g} l - 1.45 & ( 6 ) \\ {a}_{2} = 0.27 \\ {x}_{2} = 0.0167 {n}_{g} l - 0.84 \\ {y}_{2} = 0.0091 {n}_{g} l & ( 7 ) \\ {x}_{ma x} = 0.0192 {n}_{g} {l}^{′} + 0.15 \\ {y}_{ma x} = 0.0211 {n}_{g} {l}^{′} + 0.58 & ( 8 )\end{matrix}$$

If the above conditions are set, by rising and falling responses of the ring resonator can be made faster even if the carrier response speed is a little slow (several hundred ps to 1 ns) and thus, input light can be modulated at a high speed even if large pre-emphasis is not applied. The ring resonator here is not limited to the ring resonator 120 in a racetrack shape shown in FIG. 1 and applies to a closed loop optical waveguide in general including a complete round ring resonator described later. The power coupling ratio of an optical coupler (directional coupler) is assumed to be a value defined for a single optical coupler without ring resonator.

As preferable conditions in the first embodiment, Formula (9) and Formula (10) below may further be satisfied by the loss x [%] per round of the resonator and the power coupling ratio y [%] of the optical coupler 130 described above.

(x−x₀)²+(y−y₀)²≦0.25² (9)

x₀=0.0135n_{g}l′+0.09

y₀=0.0152n_{g}l′+0.17 (10)

If the above conditions should be satisfied, almost the best characteristics can be realized.

For a typical p-i-n diode made of crystal Si, Formula (8) is valid at 10 Gbps when the product of the circumference of the ring resonator 120 and series resistance of the diode at the high voltage state (V_{f}=V_{H}) is 4 Ωmm or less. If the series resistance exceeds this value, values of xₘₐₓ and yₘₐₓ decrease significantly. However, the reduction in xₘₐₓ and yₘₐₓ can be avoided if the carrier lifetime is shortened by using amorphous silicon, polysilicon, or crystal silicon doped with an impurity acting as a lifetime killer. In the first embodiment, it is necessary to provide a circular loss (20 dB/cm to 35 dB/cm in terms of an average propagation loss) satisfying conditions of the above formulae to the ring resonator. The propagation loss of the optical waveguide increases if a high impurity density region is brought closer and thus, the distance from the mesa sidewall to the high impurity density region is conventionally set to 200 nm or more. In the first embodiment, however, a circular loss is intentionally increased to satisfy the conditions of the above Formula (2) to Formula (8). Thus, the semiconductor regions 160, 170 are formed in such a way that a distance L₁ of the shortest portion from the sidewall of the mesa portion 10 on the side of the p type semiconductor region 160 to the end of the p type semiconductor region 160 and a distance L₂ of the shortest portion from the sidewall of the mesa portion 10 on the side of the n type semiconductor region 170 to the end of the n type semiconductor region 170 are both between 100 and 180 nm. With the above configuration, conditions of the Formula (2) to Formula (8) can be satisfied. The above configuration is effective for a ring resonator with a minimum radius of 7.5 μm or more. The volume of an i (intrinsic) region can be made smaller by bringing a high density region of a p-i-n diode closer to the optical waveguide mesa so that the series resistance is decreased and the response speed is also slightly improved.

In the example shown in FIGS. 1 and 2, the p type semiconductor region 160 and the n type semiconductor region 170 are formed in respective positions about 150 nm away to the left and right from the sidewall of the mesa portion 10 of the closed loop optical waveguide 121. The electrode 20 formed on the p type semiconductor region 160 is formed in a position in which the shortest distance from the sidewall of the mesa portion 10 to an edge of the electrode 20 is L₃. Similarly, the electrode 30 formed on the n type semiconductor region 170 is formed in a position in which the shortest distance from the sidewall of the mesa portion 10 to an edge of the electrode 30 is L₄. Here, L₃=L₄=500 nm is set. Both of the electrodes 20, 30 use nickel silicide and are ohmically contacted onto the p type semiconductor region 160 and the n type semiconductor region 170, respectively. Here, the carrier density of the p type semiconductor region 160 and the n type semiconductor region 170 is each set to about 1×10²⁰ cm⁻³. While the series resistance of a p-i-n diode at V_{f}=V_{H} in the first embodiment is about 40Ω, a thin-film resistor of 60Ω is integrated in parallel so that impedance matching is possible even at V_{f}=V_{L}, where the differential resistance of the diode is large.

As shown in FIG. 3, a distance L₅ of the shortest portion from the sidewall of the mesa portion 10 on the side of the p type semiconductor region 160 to the end of the p type semiconductor region 160 and a distance L₆ of the shortest portion from the sidewall of the mesa portion 40 on the side of the n type semiconductor region 172 to the end of the n type semiconductor region 172 are both set to 400 nm in the optical coupler 130 portion. In the optical coupler 130 portion, the electrode 20 formed on the p type semiconductor region 160 is formed in a position in which the shortest distance from the sidewall of the mesa portion 10 to an edge of the electrode 20 is L₇. Similarly, in the optical coupler 130 portion, the electrode 32 formed on the n type semiconductor region 172 is formed in a position in which the shortest distance from the sidewall of the mesa portion 40 to an edge of the electrode 32 is L₈. Here, L₇=L₈=800 nm is set. A region between the semiconductor region 160 of (p+) type and the semiconductor region 172 of (n+) type including the mesa portions 10, 40 becomes the i-Si region 140 of a p-i-n diode structure. Also here, the gap between the mesa portions 10, 40 is set to 380 nm.

In FIG. 4, a diagram showing an example of the relationship between a distance from a mesa portion sidewall to a p+ region and an n+ region and an optical propagation loss by free carrier absorption is shown. In FIG. 4, the relationship between the distance from the sidewall of the mesa portion 10 to the p type semiconductor region 160 or the n type semiconductor region 170 and the optical propagation loss by free carrier absorption in a linear rib optical waveguide of a structure shown in FIGS. 1 to 3.

The distribution of optical power in an optical waveguide in a curved portion of the closed loop optical waveguide 121 is more concentrated on the outer side so that absorption in the high impurity doped region on the outer side becomes stronger than absorption in the optical waveguide of a linear portion. Thus, an actual optical resonator suffers a little greater loss than indicated by the curve in FIG. 4. If the conventional method is followed, a region corresponding to the p type semiconductor region 160 and a region corresponding to the n type semiconductor region 170 will be arranged in positions 400 nm or more away from the mesa 10 to reduce the guided wave loss caused by free carrier absorption. However, if such a conventional structure is followed, the circular loss of the ring resonator including a scattering loss due to the sidewall roughness of the mesa portion, radiation loss in a curved waveguide, mode conversion loss in a connection portion of a curved waveguide and a linear waveguide, and reflection/scattering loss of a directional coupler is 10 to 15 dB/cm in terms of an average propagation loss per unit length. However, in a ring optical modulator according to the present embodiment, the average guided wave loss per unit length of the ring resonator 120 excluding the optical coupler 130 is about 25 dB/cm by intentionally bringing the p type semiconductor region 160 and the n type semiconductor region 170 closer to a position 150 nm away from the mesa portion 10 of the optical waveguide to provide an excessive guided wave loss to the resonator. In this case, the resonator circular loss from the output 142 of the optical coupler 130 to the input 140 of the optical coupler 130 becomes about 3.8%.

If the loss of the optical coupler 130 is ignored, a so-called critical coupling occurs when the circular loss of the ring resonator 120 and the power coupling ratio of the optical coupler 130 are equal. Under the critical coupling condition, at the resonant wavelength of the ring resonator 120, the intensity of light coupling from the ring resonator 120 to the input/output optical waveguide 110 and the intensity of light propagating directly through the input/output optical waveguide 110 are equal and phases thereof are shifted by 180 degrees. The output power at a light output port 112 of the input/output optical waveguide 110 is nearly zero due to interference of lights with equal intensity and opposite phases and thus, almost all input light from a light input port 111 is captured by the ring resonator 120. To simplify the description that follows, a case when both of the circular loss and the power coupling ratio are 1% will be considered. If input light power from the input/output optical waveguide 110 is assumed to be 1 mW, this condition is satisfied if power of an input port 150 on the side of the ring resonator 120 of the optical coupler 130 is 99 mW and in this case, power of an output port 152 on the side of the ring resonator 120 is 100 mW. In other words, the critical coupling is considered to be a state in which the supply rate (1 mW=1 mJ/s in the above case) of light from the side of the light input port 111 of the input/output optical waveguide 110 and the rate (1 mJ/s in the above case) at which light is lost inside the ring resonator 120 are balanced so that the output is almost zero. To obtain a large extinction ratio, it is necessary to use the ring optical modulator in a state close to the critical coupling, but 10 dB or so is enough for the extinction ratio of a fast optical modulator and thus, a deviation to some extent is allowed. The power coupling ratio (including the coupling in a curved approach portion) of a directional coupler 3 in which the interval between waveguides is 380 nm in the present embodiment is 4.4% and the ring optical modulator is designed to slightly deviate from the critical coupling.

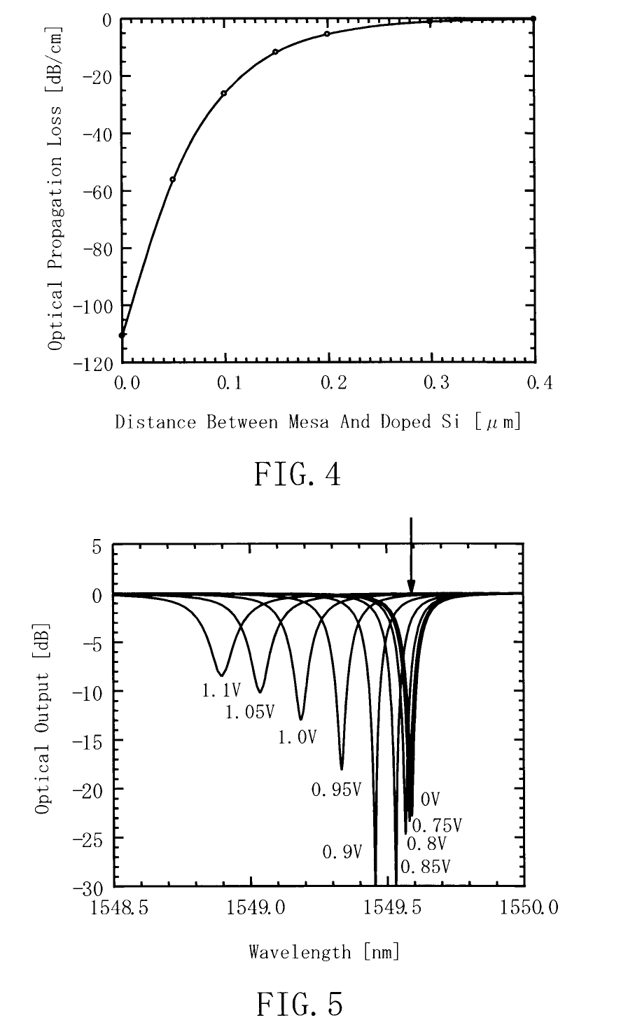

In FIG. 5, a diagram showing changes of a transmission spectrum near the wavelength 1549 nm of the ring optical modulator according to the first embodiment by voltage application is shown. In FIG. 5, the vertical axis denotes optical output and the horizontal axis denotes the wavelength. For the vertical axis, the transmittance in a transmission wavelength range is set to 0 dB by subtracting an insertion loss. The temperature of elements is maintained constant so that the elements are not affected by heat generated by the current injection. Incidentally, if the temperature rises due to the injection of current, the effective refractive index increases and thus, the amount of resonant wavelength shift becomes ½ or less of the amount in FIG. 5. If the contrast of the output spectrum is sufficiently large (generally 6 dB or more), the quality (Q) factor of the resonator can be estimated from the ratio Δλ/λᵣ of the wavelength width Δλ in which the transmittance is −3 dB or less to the resonant wavelength λᵣ. In this case, the resonant wavelength at V_{f}=0 V is 1549.59 nm and the Q factor is 1.43×10⁴. The resonant wavelength is 1549.58 to 1549.59 nm below the turn-on voltage (˜0.75 V) of the diode and hardly changes. The refractive index decreases due to an increase in injection carrier density above the turn-on voltage and so the resonant wavelength shifts toward the side of the shorter wavelength. Moreover, the circular loss of the resonator increases with increasing free carrier absorption and thus, the Q factor drops and the spectral bandwidth broadens. The critical coupling occurs at a voltage between 0.85 and 0.9 V, where the resonance becomes deepest. When the voltage is further increased, the circular loss of the resonator exceeds the power coupling ratio of the coupler, gradually decreasing the contrast. (In actual measurement, the contrast often remains in the range of 10 to 20 dB even in the vicinity of critical coupling conditions due to imperfection of elements or an influence of the light source spectral bandwidth, but trends of the change are likewise.)

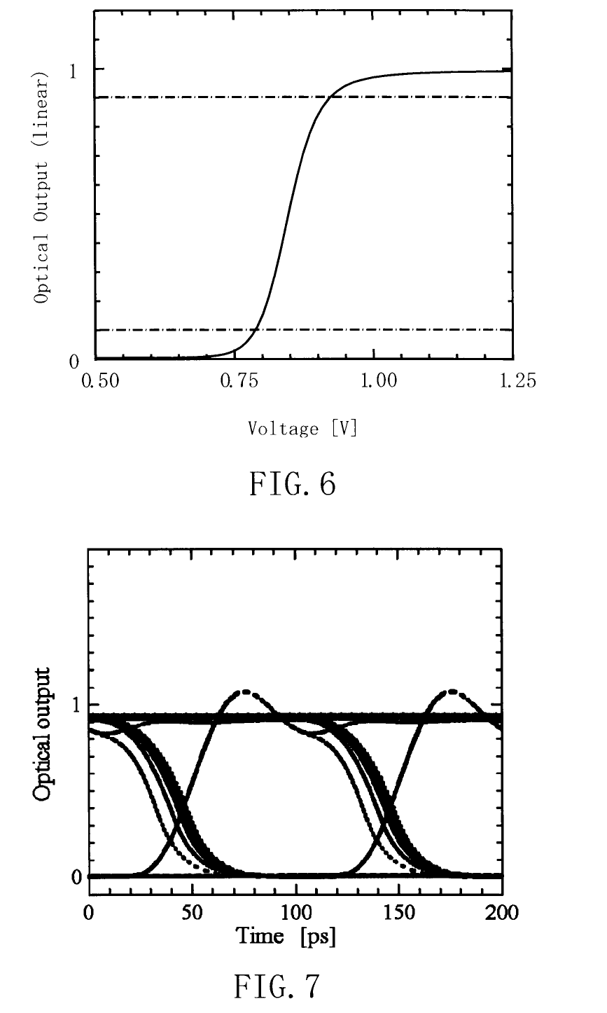

In FIG. 6, a diagram showing DC voltage-optical output characteristics at a wavelength of 1549.59 nm (indicated by an arrow in FIG. 5) of the ring optical modulator according to the first embodiment is shown. If the wavelength 1549.59 nm deviates from the stop band due to the resonant wavelength shift caused by voltage application, the transmission state is maintained regardless of subsequent changes of the resonant wavelength or resonance spectrum shape. Thus, the output changes considerably between V_{10%}=0.79 V and V_{90%}=0.93 V. If this input/output characteristic like a digital switch is used, an almost constant optical output is obtained when the carrier density exceeds a certain value (about 1.5×10¹⁷ cm⁻³ in the present embodiment). By using this effect, the optical modulator can be made to operate faster than the response speed of the carrier density.

However, the response speed of the ring optical modulator is constrained also by the buildup time (time constant before the light power in the resonator reaches a steady state after the diode is turned off to restore a resonant state) of the resonator and the photon lifetime (time constant before the light accumulated in the resonator is lost after the resonant wavelength is shifted by turning on the diode). The buildup time of the resonator is given by τ˜Q/ωᵣ and a fast response cannot be obtained if the Q factor is too high. Here, ωᵣ is the angular frequency of resonant light. It is necessary to reduce the buildup time to about 20 ps or less to let the resonator respond to 10 Gbps, and hence, the Q factor needs to be reduced to 2.4×10⁴ or less at the wavelength 1550 nm (194 THz). The Q factor of the resonator of the ring optical modulator in the present embodiment when no voltage is applied is 1.4×10⁴ and this condition is satisfied. However, this condition is a necessary condition and a fast operation cannot be realized only by controlling the Q factor.

Input light of the wavelength of 1549.59 nm is modulated by an NRZ pseudo random sequences (2¹⁰−1) at 10 Gbps using the ring optical modulator 100 according to the first embodiment. The levels of the voltage V_{f} applied to the electrode 20 are set to V_{L}=0.5 V and V_{H}=0.95 V. That is, a modulating signal of the voltage amplitude 0.45 Vₚₚ is superimposed on a DC bias voltage of 0.725 V. The rise time and the fall time are each 25 ps.

In FIG. 7, a diagram showing simulation results of a modulated optical waveform at the output port of an input/output optical waveguide according to the first embodiment is shown. In a simulation of the modulated light waveform at the light output port 112 of the input/output optical waveguide 110, the average power consumption of the ring optical modulator 100 is 0.26 mW and modulation energy per bit is 0.026 pJ/bit. (Actually, considerable power is consumed by an impedance matching thin-film resistor. However, if a CMOS drive circuit is monolithically integrated near the optical modulator so as to be handled as a lumped constant circuit, the resistor for impedance matching becomes unnecessary.)

As shown in FIG. 7, there is a small overshoot when a curve rises and as a result, the rise delay is canceled out to some extent. The trace in a falling portion is branched out into a plurality of traces because if “1” (Mark) continues for a longer period, the carrier density continues to increase and thus, the time necessary to extract accumulated carriers when the diode is turned off becomes longer. Under the drive condition, an increase in delay time with respect to the consecutive count of “1” is almost saturated. Therefore, even if the number of stages of the pseudo random sequences is increased, an optical response waveform is not much degraded.

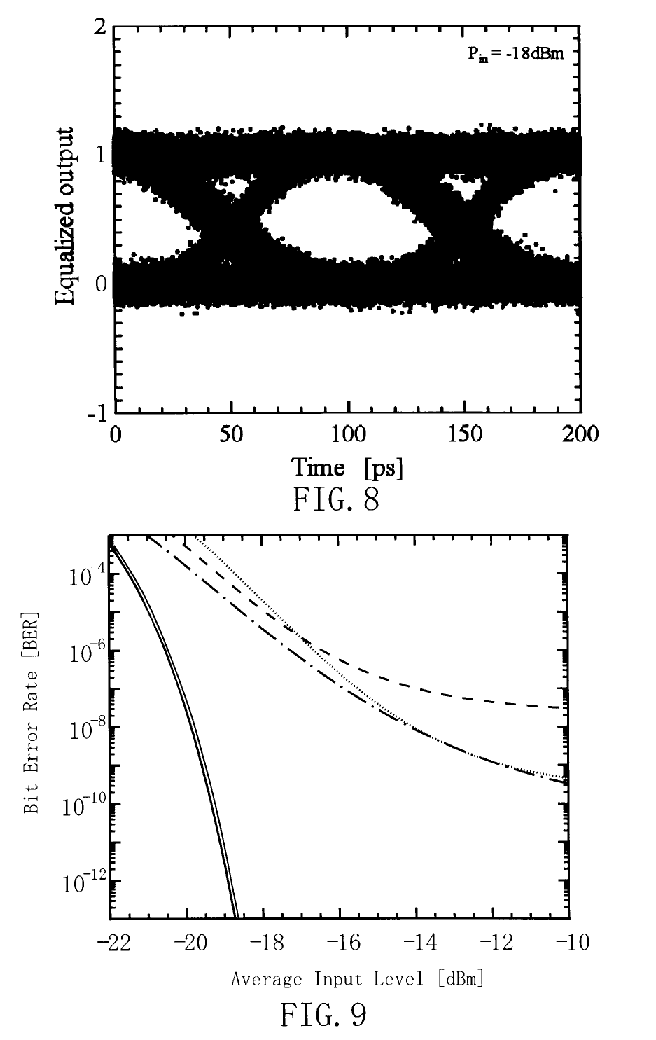

In FIG. 8, a diagram showing an eye pattern after an optical signal modulated by the ring optical modulator according to the first embodiment is received/equalized by an optical receiver optimized for 10-Gbps transmission is shown. The average input power into an optical receiver is −18 dBm.

The thick solid line in FIG. 9 shows the relationship between an average optical receiver input level and a bit error rate (BER) according to the first embodiment. The minimum receiving level Pₘᵢₙ when BER=10⁻¹¹ is about −19 dBm.

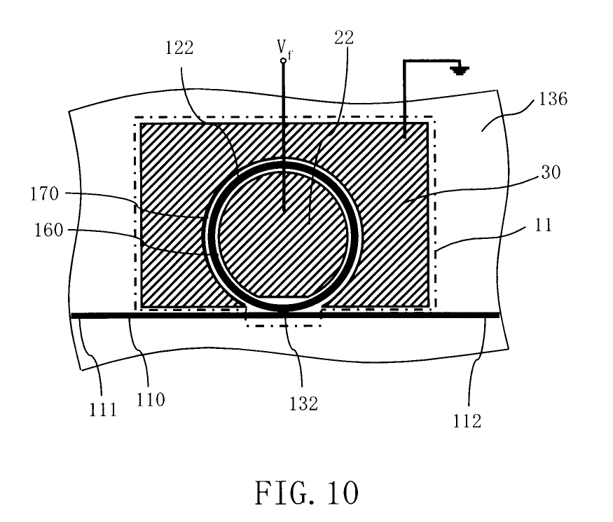

In FIG. 10, a top view showing another example of the configuration of the ring optical modulator according to the first embodiment is shown. FIG. 10 is the same as FIGS. 1 to 3 except that the ring resonator 120 in a racetrack shape is replaced by a ring resonator 122 in a circular shape without any linear portion, the slab portion 11 is limited to a range surrounded by an alternate short and long dashed line in FIG. 10, the optical coupler 130 is replaced by an optical coupler 132, the electrode 20 is replaced by an electrode 22, and the electrode 32 on the side of the input/output optical waveguide 110 in the optical coupler 132 is eliminated. Incidentally, the Si layer 134 is completely removed on the outer side of the alternate short and long dashed line of FIG. 10 and the SiO₂ layer 136 is exposed. In the example in FIG. 10, in the optical coupler 132 portion, the gap between the closed loop optical waveguide 121 of the ring resonator 122 and the input/output optical waveguide 110 is brought closer to 260 nm. Accordingly, the power coupling ratio is set to about 3.9%. The gap between the closed loop optical waveguide 121 and the input/output optical waveguide 110 indicates the shortest distance between sidewalls of the mesa portions 10, 40. The ring radius of the closed loop optical waveguide 121 of the ring resonator 122, optical waveguide structure, distance between the high density region and mesa portion, and distance between the electrode and mesa portion are the same as those in FIGS. 1 to 3.

The circular loss of the ring resonator 122 of the ring optical modulator shown in FIG. 10 is about 3.6%, the resonant wavelength closest to the wavelength 1550 nm when no voltage is applied is 1551.57 nm, and the Q factor is 1.36×10⁴. When the ring optical modulator is used for modulation using a 10-Gbps pseudo random sequences at V_{L}=0.5 V and V_{H}=0.95 V, the power consumption is 0.25 mW so that almost the same optical output waveform and eye pattern as those of the optical modulator shown in FIGS. 1 to 3 are obtained. Also, the bit error rate (thin solid line in FIG. 9) is equivalent (the minimum receiving level Pₘᵢₙ is −19 dBm when BER=10⁻¹¹) to that of the ring optical modulator shown in FIGS. 1 to 3 (thick solid line).

In a ring optical modulator according to the first embodiment, it is only necessary that the value of V_{L} be set sufficiently lower (0.6 V or lower in the present embodiment) than the turn-on voltage so that accumulated carriers can be extracted in a short time when the diode is turned off. However, if the internal resistance of the diode is high, it is necessary to further lower V_{L} to accelerate extraction of accumulated carriers. If necessary, V_{L} may be set below 0 V at the sacrifice of the modulation amplitude.

On the other hand, if V_{H} is set too high, the maximum carrier density increases and the turn-off delay of the diode becomes longer, which deteriorates the eye opening.

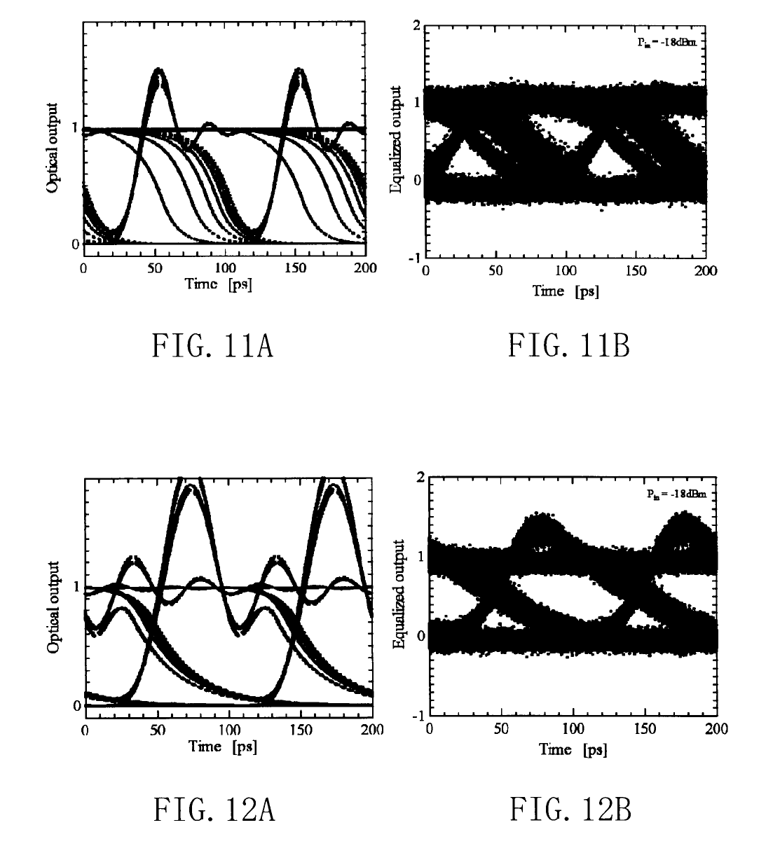

FIGS. 11A and 11B show an example of simulation results of an optical output waveform and the eye pattern, respectively, when V_{H} is too high. FIG. 11A shows the optical output waveform of the ring optical modulator according to the first embodiment in a circular shape shown in FIG. 10, when V_{H} is raised to 1.1 V while V_{L} is kept at 0.5 V. FIG. 11B shows a corresponding eye pattern after reception/equalization. The rate of change in the carrier density is too large and thus, as shown in FIG. 11A, an overshoot of the optical output waveform is large and the period of relaxation oscillation is shortened. Also, the width of falling traces is broadened due to an increased turn-off delay of the diode. As a result, as shown by a thin broken line in FIG. 9, a BER floor appears at around 10⁻¹⁰. An increase in delay time is not yet saturated even if 10 Mark bits “1” occur consecutively and thus, if the number of stages of the pseudo random sequences is still longer, the breadth of falling traces is further increased and the floor level is also raised. The average power consumption is 1.04 mW, which is about four times as large as the average power consumption when V_{H}=0.95 V. Therefore, the value of V_{H} needs to be set high enough so that input/output characteristics like a digital switch can be utilized and also in such a way that the influence of the diode turn-off delay is not so noticeable. For the optical modulator in the present embodiment, the range of V_{H}=0.9 to 0.95 V is optimal. Also for the embodiments described below, it is assumed that the drive voltage level is set close to the optimal state.

FIGS. 12A and 12B shows an example of simulation results of an optical output waveform and an eye pattern, respectively, when the distance between a mesa portion and the high-carrier-density regions is too large. FIG. 12A shows a 10 Gbps optical output waveform of the ring optical modulator according to the first embodiment having a racetrack resonator shown in FIG. 1, when the distance from the sidewall of the mesa portion 10 to the p type semiconductor region 160 and the n type semiconductor region 170 is increased to 400 nm, which is a typical value of conventional technology. FIG. 12B shows a corresponding eye pattern after reception/equalization. With the above configuration, the circular loss of the ring resonator is about 1.55% (average propagation loss per unit length is about 10 dB/cm) and the power coupling ratio is set to 1.64% by broadening the gap of the optical coupler to 450 nm to bring closer to the critical coupling condition. Because the Q factor (3.7×10⁴) of the resonator is too high, as shown in FIG. 12A, a relaxation oscillation component in the optical output waveform is large and the fall time is long. Thus, as shown in FIG. 12B, a portion of the eye pattern lies beyond the boundary of the eye mask. As shown by a broken line in FIG. 8, the BER floor level is as high as 3×10⁻⁸. Incidentally, even if a ring optical modulator of such a conventional structure can realize 10-Gbps optical modulation by pre-emphasis, an overshoot as shown in FIGS. 12A and 12B appears and therefore, eye mask criteria cannot be passed.

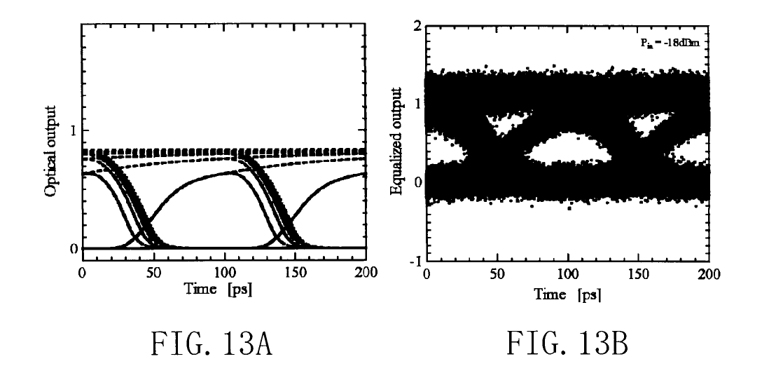

FIGS. 13A and 13B show an example of simulation results of the optical output waveform and the eye pattern, respectively, when the distance between the mesa portion and the high-carrier-density regions is too small. decreased and an example of the eye pattern after reception/equalization according to the first embodiment are shown. FIG. 13A shows a 10 Gbps optical output waveform (simulation) of the ring optical modulator according to the first embodiment having the racetrack resonator shown in FIG. 1, when the distance from the sidewall of the mesa portion 10 to the p type semiconductor region 160 and the n type semiconductor region 170 is set to 90 nm. FIG. 13B shows a corresponding eye pattern after reception/equalization. The circular loss is about 7.5% (50 dB/cm), the gap between optical waveguides of the optical coupler is 340 nm (power coupling ratio: 7.8%), and the Q factor is 7.5×10³. With a rise delay and a lower extinction ratio, as shown in FIG. 13B, eye pattern traces are broadened and the eye opening is decreased so that eye mask criteria cannot be passed. As shown as an alternate long and short dashed line in FIG. 9, a BER floor appears on the order of 10⁻¹⁰.

Light receiving characteristics of the ring optical modulators shown in FIGS. 1 and 10 when the circular loss of the resonator and the power coupling ratio of the optical coupler are allocated in a matrix form are evaluated by using a simulation. Criteria for the evaluation are the following three points:

(1) The eye pattern does not lie beyond the boundary of the eye mask defined by ITU-T.
(2) The ratio of the average “1” (Mark) level and the average “0” (Space) level of the eye can be set to 10:1 or more.
(3) Data can be received with a bit error rate of 10⁻¹¹ or less.

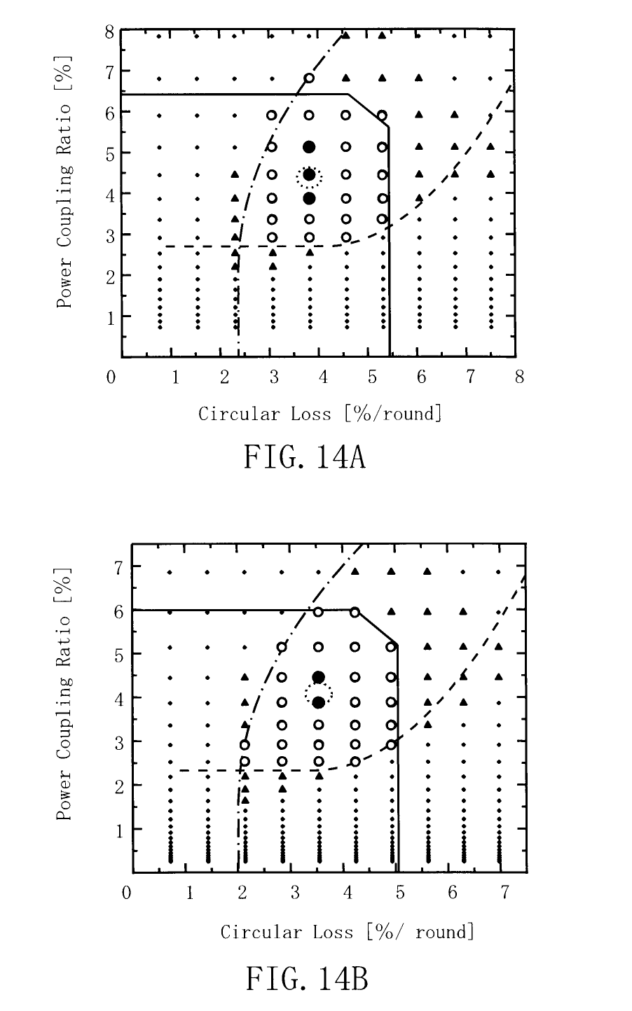

In FIGS. 14A and 14B, diagrams showing light receiving characteristics when a circular loss of the resonator and a power coupling ratio of the optical coupler according to the first embodiment are allocated in a matrix form are shown. In FIGS. 14A and 14B, the vertical axis denotes the power coupling ratio and the horizontal axis denotes the circular loss. FIG. 14A shows light receiving characteristics of the ring optical modulator shown in FIG. 10. FIG. 14B shows light receiving characteristics of the ring optical modulator shown in FIG. 1. The mark indicates a point where the best characteristics are obtained (minimum receiving level is about −19 dBm), the ◯ mark indicates a point whose the power penalty is less than 1.5 dB, and the ▴ mark indicates a point where more penalties are imposed. According to mathematical calculation, it is assumed that noise of the light source can be ignored, and an ideal optical receiver for 10 Gbps is used for reception and under these preconditions, excellent optical transmission characteristics can be realized if the circular loss and power coupling ratio are set to the range of the and ◯ marks.

If noise is superimposed on an optical waveform due to insertion of an optical amplifier or the like or the optical receiver is inferior in performance, the reduction of a region of the ◯ mark, an increased minimum receiving level, and deterioration of receivable bit rates will be invited. In such cases, compared with the above embodiment, it is necessary to increase the optical input level of the optical receiver or lower the transmission rate. However, if the circular loss of the resonator of the ring optical modulator and the power coupling ratio set to a region of the marks, almost the best optical transmission characteristics using the optical receiver can be realized.

Light of the resonant wavelength is confined within the resonator due to interference in a directional coupler under conditions near the critical coupling and thus, the lifetime of light captured within the resonator is determined almost exclusively by the circular loss. Therefore, to make the resonator respond fast, it is necessary to shorten the photon lifetime by providing a somewhat large circular loss to the resonator. Conversely, if the circular loss is too large (the Q factor is too small), an adequate extinction ratio or sharp input/output characteristics cannot be obtained, which indicates that the optimal value of the circular loss exists. From FIGS. 14A and 14B, it is clear that the circular loss of the resonator is preferably set to 3.5 to 4%, and at least 2% or more of the circular loss is needed for the type of FIG. 1, as shown in FIG. 14B, and 2.5% or more of the circular loss is needed for the type of FIG. 10, as shown in FIG. 14A.

The circular loss of the resonator of a conventional ring optical modulator whose radius is 10 μm is around 1.5% and conditions for responding to 10 Gbps cannot be obtained only by adjusting the Q factor of the resonator through the power coupling ratio of the optical coupler.

If, in a standard ring resonator (radius: 10 μm±2.5 μm) of a Si rib waveguide structure (width of the mesa portion: 450±60 nm, Si thickness of the mesa portion: 220±30 nm, Si slab thickness: 50±15 nm), the circular loss should be optimized in the distance from the optical waveguide to the high impurity density region (carrier density: 5×10¹⁹ cm⁻³ or more), it is necessary to bring at least one of the p+ region or the n+ region closer to the Si mesa sidewall up to 100 to 180 nm therefrom.

In the first embodiment, the circular loss of the resonator is controlled using the distance between the p+ region or n+ region and the mesa portion of the optical waveguide as a variable, but a method of controlling the carrier density of a p region and an n region formed near the optical waveguide by adopting a p⁺-p⁻-i-n⁻-n⁺ structure for the diode may be used.

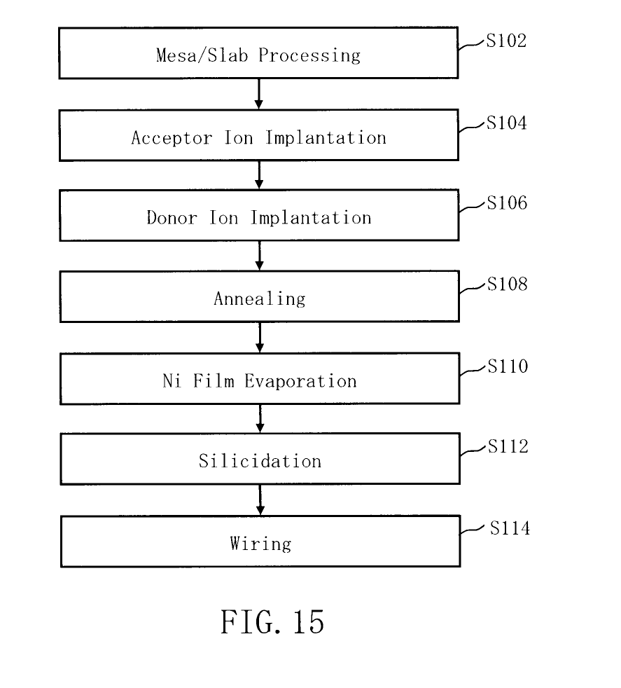

In FIG. 15, a flow chart showing principal processes of a method for fabricating the ring optical modulator according to the first embodiment is shown. In FIG. 15, a method for fabricating a ring optical modulator according to the first embodiment performs a series of processes including a mesa/slab processing process (S102), an acceptor ion implantation process (S104), a donor ion implantation process (S106), an anneal process (S108), a metal film formation process (S110), a silicidation process (S112), and a wire and resistance film formation process (S114).

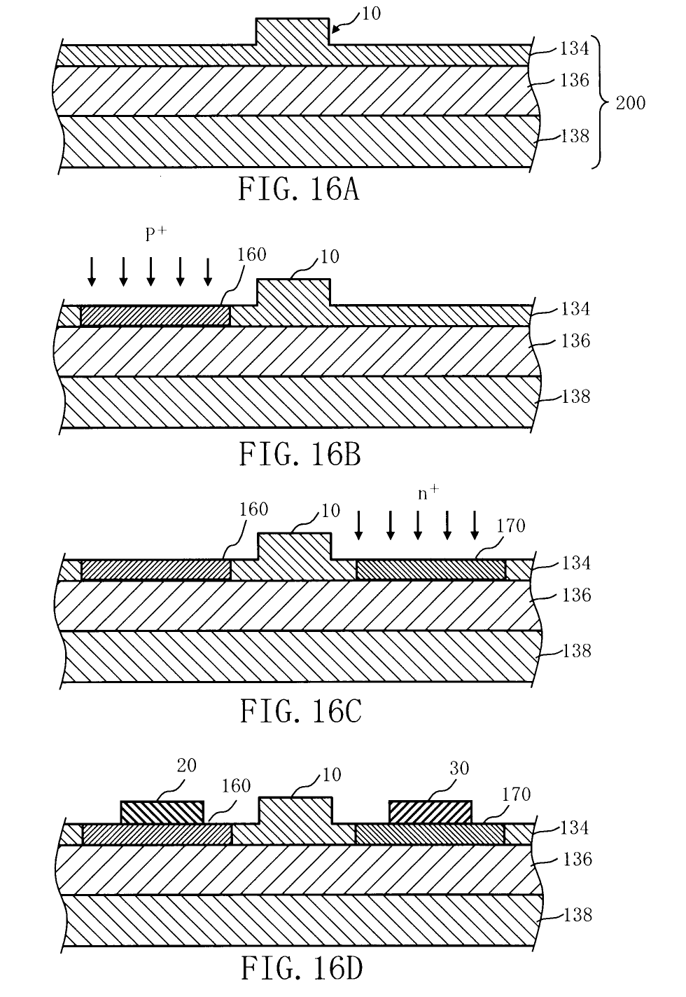

In FIGS. 16A to 16D, process sectional views of the ring optical modulator according to the first embodiment are shown. In FIGS. 16A to 16D, cross sections of the ring resonators 120, 122 are shown. Illustrations of the cross section of the optical coupler portions 130, 132 of the ring resonators 120, 122 and the cross section of the input/output optical waveguide 110 are omitted. A photo resist and/or a dielectric film are used as a mask in each process, but the description thereof is omitted to simplify the description.

In FIG. 16A, as the mesa/slab processing process (5102), the top Si layer 134 of an SOI substrate 200 is etched by dry etching while leaving a region of the mesa portion 10 to form a rib optical waveguide structure with the mesa portion 10 and the slab portion 11. Subsequently, the slab portion 11 is also etched in a region outside the optical modulator to expose the SiO₂ layer 136, an illustration thereof is omitted.

In FIG. 16B, as the acceptor ion implantation process (S104), acceptor impurities are ion-implanted into a portion of the slab portion 11 positioned on the side of one sidewall of the mesa portion 10 to form the semiconductor region 160 of p type. Here, as described above, the semiconductor region 160 of p type is formed in a position a set distance away from the sidewall of the mesa portion 10. For example, boron (B) is used as the acceptor.

In FIG. 16C, as the donor ion implantation process (S106), donor impurities are ion-implanted into a portion of the slab portion 11 positioned on the side of the other sidewall of the mesa portion 10 to form the semiconductor region 170 of n type. Also here, as described above, the semiconductor region 170 of n type is formed in a position the set distance away from the sidewall of the mesa portion 10. For example, phosphorus (P) is used as the donnor.

Then, as the anneal process (S108), after the acceptors and the donors being ion-implanted, annealing is performed to activate the impurities and to relax the implantation damage. Accordingly, the p type semiconductor region 160 and the n type semiconductor region 170 are made less resistive and stabilized.

In FIG. 16D, as the metal film formation process (5110), an Ni (or Ti) film is evaporated on the p type semiconductor region 160 and the n type semiconductor region 170 in respective positions a set distance away from the sidewall of the mesa portion 10.

Then, as the silicidation process (S112), a portion of the Ni (or Ti) film in contact with the Si slab is silicidated by performing annealing to form ohmic contacts. Further, by undergoing the process (S114) of forming a wire metal and, if necessary, a thin-film resistor, the ohmic electrodes 20, 30 and a pad (or an integrated drive circuit) are connected (not illustrated). Though not illustrated, to reduce a scattering loss of light due to the sidewall roughness of the mesa portion, the surface of a portion of the i-Si region 140 including the mesa portion 10 is suitably oxidized lightly.

By configuring as described above, a ring optical modulator according to the first embodiment can be fabricated.

According to the first embodiment, as described above, the rate at which light of the resonant wavelength is captured by a ring resonator and the rate at which light of the resonant wavelength is consumed by the ring resonator are both large and thus, the buildup time of the resonator and the photon lifetime are short. Moreover, the two rates are approximately balanced and so a sufficiently large extinction ratio can be obtained. As a result, digital optical switch-like responses are maintained and a sufficiently large extinction ratio and a symmetrical eye opening can be obtained from small modulation voltage amplitude (<1 V). As a result, a fast (up to 10 Gbps) optical modulation operation with low drive voltage/low power consumption without pre-emphasis, which is impossible with a conventional carrier injection optical modulator of the p-i-n diode structure, can be realized.

### Second Embodiment

In the first embodiment, conditions of Formula (2) to Formula (8) are satisfied by controlling the circular loss of the resonator using the distance between the p+ region or n+ region and the mesa portion of the optical waveguide as a variable, but the method of controlling the circular loss is not limited to the above method.

In the second embodiment, the radiation loss is increased by setting the curvature radius of the ring resonator to 5 to 7.5 μm. A mode conversion loss in a connection portion of an optical waveguide whose curvature radius is small and a linear waveguide or in an inflection point of an S-shaped optical waveguide whose curvature radius is small also contributes to an increase in circular loss of the resonator. Reducing the ring diameter is also useful from the viewpoint of making the footprint of an optical modulator smaller. If the circumference is predetermined from the resonant wavelength period, a waveguide in an arc shape whose curvature radius is small may be used for a portion of the ring resonator. Points not specifically mentioned below are the same as in the first embodiment.

When the ring radius is reduced, the circular loss of the resonator is increased through an increase of the radiation loss, an increase of the scattering loss due to a mode mismatch of a curved portion and a linear portion and the like. In a ring optical modulator having, for example, the radius of 5 μm and the optical coupler (directional coupler) length of 0 μm (circumference: about 31.4 μm), the circular loss is 2.1 to 2.5% (mostly 30 to 35 dB/cm and a little varied depending on elements) even if the interval between the high impurity density region and the mesa portion is set to 300 nm or more and thus, the circular loss can be made larger than when the radius is 10 μm. The power coupling ratio when the gap between optical waveguides in the directional coupler is 240 nm is about 2.4% and the Q factor when no voltage is applied is 1.2×10⁴. The series resistance of diode when highly injected is about 100Ω. Also with this optical modulator, 10-Gbps transmission with the minimum receiving sensitivity of −18.5 dBm at BER=10⁻¹¹ is possible.

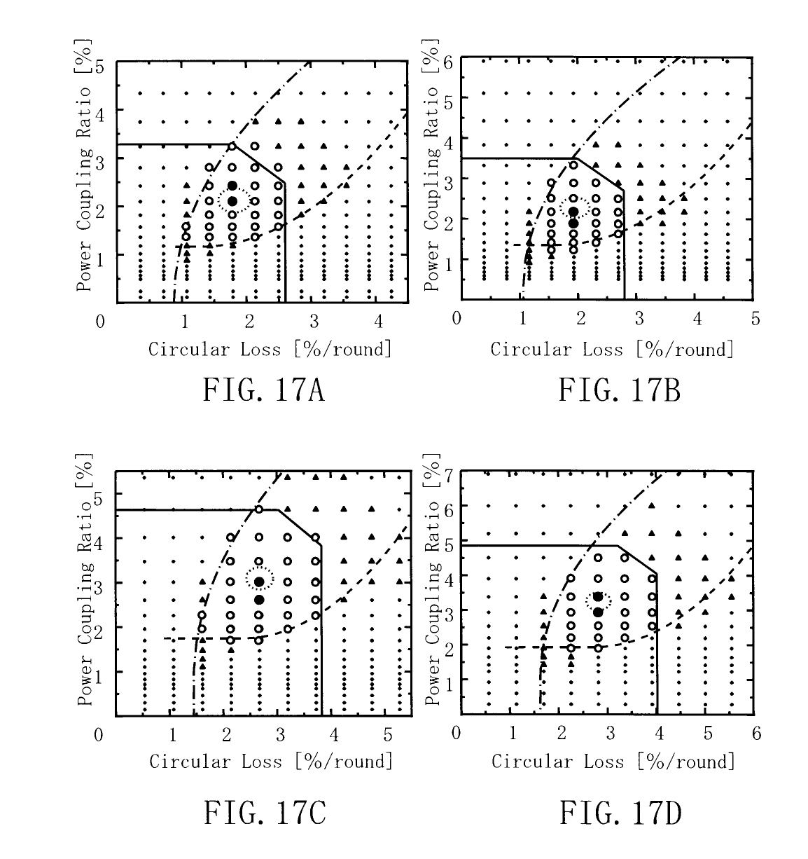

In FIGS. 17A to 17D, diagrams showing evaluation results of transmission characteristics when the circular loss of the resonator and the power coupling ratio of the optical coupler according to the second embodiment are changed are shown. FIG. 17A shows evaluation results of transmission characteristics when the curvature radius of the ring resonator is 5 μm and the length of the directional coupler is 0 μm. FIG. 17B shows evaluation results of transmission characteristics when the curvature radius of the racetrack type ring resonator is 5 μm and the length of the directional coupler is 2.5 μm (circumference: about 36.4 μm, series resistance: about 100Ω). FIG. 17C shows evaluation results of transmission characteristics when the curvature radius of the ring resonator is 7.5 μm and the length of the directional coupler is 0 μm (circumference: about 47.1 μm, series resistance: about 66.7Ω). FIG. 17D shows evaluation results of transmission characteristics when the curvature radius of the racetrack type ring resonator is 7.5 μm and the length of the directional coupler is 2.5 μm (circumference: about 52.1 μm, series resistance: about 66.7Ω). Like in FIGS. 13A and 13B, the mark indicates a point where the best characteristics are obtained (minimum receiving level ˜−19 dB), the ◯ mark indicates a point whose power penalty is less than 1.5 dB, and the ▴ mark indicates a point where more penalties are imposed. In the numerical calculation, it is assumed that noise of the light source can be ignored and an ideal optical receiver for 10 Gbps is used for reception, and under these preconditions, like in FIGS. 13A and 13B, excellent optical transmission characteristics can be realized if the circular loss and power coupling ratio are set to the range of the and ◯ marks.

In a ring optical modulator having, for example, the radius of 5 μm and the optical coupler (directional coupler) length of 0 μm (circumference: about 31.4 μm), if, as shown in FIG. 17A, the circular loss can be reduced a little more, 10-Gbps optical transmission with the minimum receiving sensitivity of −19 dBm at BER=10⁻¹¹ becomes possible.

FIGS. 17A to 17D show that the optimal range of the circular loss of the ring resonator and the power coupling ratio of the directional coupler shifts in a direction in which the values decrease with a decreasing circumference. For example, the circular loss of the ring resonator having the radius of 7.5 μm was slightly smaller than 2%, which is smaller than optimal conditions of FIGS. 17A to 17D. On the other hand, losses vary greatly when the radius is 5 μm or less and losses increase rapidly when the radius falls below 4 μm, falling outside the receivable range. This shows that when resonator losses should be adjusted only by reducing the ring radius while keeping an excessive loss by the high impurity density region at an ignorable level (the interval between the high impurity density region and the mesa is 300 nm or more), it is preferable to set the radius to a range of 5 to 7.5 μm, preferably near 6 p.m.

If the radius of the resonator is reduced, the resonant wavelength period and resonant wavelength band are broadened. If the circumference of the ring resonator cannot be reduced much due to spec constraints, the following configuration is also suitable.

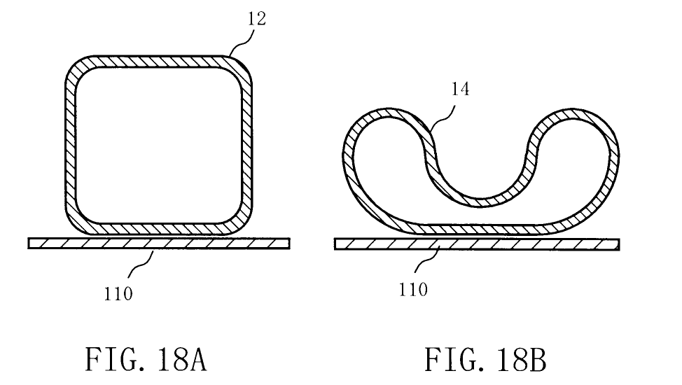

In FIGS. 18A and 18B, diagrams showing an example of the shape of the ring resonator according to the second embodiment are shown. FIG. 18A shows a closed loop optical waveguide 12 with four corners and four straight lines in other portions. By adopting the above shape, the circular loss of the resonator can be increased without reducing the circumference by providing small-radius corners in the ring resonator 12.

FIG. 18B shows another example of the shape of the ring resonator according to the second embodiment. In FIG. 18B, the upper half of the closed loop waveguide gets into the inner side of the lower half. By adopting the above shape, the circular loss of the resonator can be increased without reducing the circumference by providing small-radius portions in the ring resonator 12.

In the second embodiment, as described above, the ring resonator 12 has a plurality of curved portions in a closed loop optical waveguide and the individual curved portion may have a curvature radius different from the other curved portions.

Also, according to the second embodiment, as described above, even if no circular loss is caused by adjusting the distance between the p+ region or n+ region and the mesa portion of an optical waveguide, the circular loss can be adjusted by adjusting the curvature radius of a closed loop optical waveguide. As a result, like the first embodiment, digital optical switch-like responses are maintained and a sufficiently large extinction ratio and a symmetrical eye opening can be obtained from small modulation voltage amplitude (<1 V). As a result, a fast (up to 10 Gbps) optical modulation operation with low drive voltage/low power consumption without pre-emphasis, which is impossible with a conventional carrier injection optical modulator of the p-i-n diode structure, can be realized.

Conditions of Formula (2) to Formula (8) to determine the circular loss x [%] and the power coupling ratio y of an optical coupler enabling 10-Gbps transmission described in each of the above embodiments can be derived from transmission characteristics evaluation results shown in FIGS. 13A, 13B, and 17A to 17D. The group index of refraction of the optical waveguide of each of the above embodiments is set to 4.07. In FIGS. 13A, 13B, and 17A to 17D, the boundary of Formula (2) is indicated by an alternate short and long dashed line. The boundary of Formula (3) is indicated by a broken line. The boundary of Formulae (4) and (5) is indicated by a solid line. 10-Gbps transmission can be performed by using a high-performance optical receiver in regions surrounded by these boundaries. Boundaries of Formulae (9) and (10), which are conditions for obtaining more optimized characteristics, are indicated by a thin broken line inside regions surrounded by the solid line, alternate short and long dashed line, and broken line in FIGS. 13A, 13B, and 17A to 17D.

Even if characteristics of the optical receiver are not ideal, the best optical transmission characteristics can be obtained if a decreased top transmission rate or an increased minimum receiving level is permitted.

If the circular loss of a resonator is converted into an average propagation loss, the range of the average propagation loss satisfying Formulae (2) to (8) becomes a range of a little less than 20 dB/cm to 35 dB/cm. Best characteristics are obtained when the average propagation loss of a ring resonator is around 25 dB/cm.

Incidentally, boundaries specified by Formulae (4), (5), (8) also depend on the response time of carrier determined by the series resistance of diode, parasitic capacitance, carrier lifetime and the like. The constants in Formula (8) have been determined from the results for the modulators with the best characteristics near the wavelength 1.55 μm at the data rate 10 Gbps. If the product of the contact resistance and parasitic capacitance is larger, the range in which excellent optical transmission characteristics can be obtained becomes narrower and the minimum received power level also increases. Assuming the carrier lifetime of typical crystal Si, it is preferable to reduce the product of the circumference and the series resistance of diode at V=V_{H} to 4 Ωmm or less. The value of series resistance Rₛ of diode at V=V_{H} can be determined by fitting DC voltage (V)−current (I) characteristics to the following Formula (11) representing diode characteristics.

$$I = {I}_{s} [ exp ( \frac{q ( V - {R}_{s} I )}{nkT} ) - 1 ] \qquad ( 11 )$$

where Iₛ is the saturation current, n is the ideality factor of the diode, k is the Boltzmann constant, T is the absolute temperature, and q is the electron's elementary charge. The influence of the carrier response time on the boundaries defined by Formulae (2), (3), (6), and (7) is relatively small.

When the data rate is lowered, the optimal ranges in FIGS. 13A, 13B, and 17A to 17D broaden to the lower left and upper right, but the upper left and lower right boundaries do not move much. Conversely, if the data rate is increased, the optimal ranges become narrower, but if conditions of Formulae (9) and (10) are satisfied, the above-mentioned criteria (1) to (3) can be satisfied up to about 15 Gbps. However, in consideration of practical tolerance, it is desirable to seek to reduce the response time of carriers simultaneously when the present embodiment is applied to optical modulation at a data rate exceeding 10 Gbps.

### Third Embodiment

The method of controlling the circular loss is not limited to the above embodiments. In the third embodiment, the circular loss is controlled by making the closed loop optical waveguide of a ring resonator athermal.

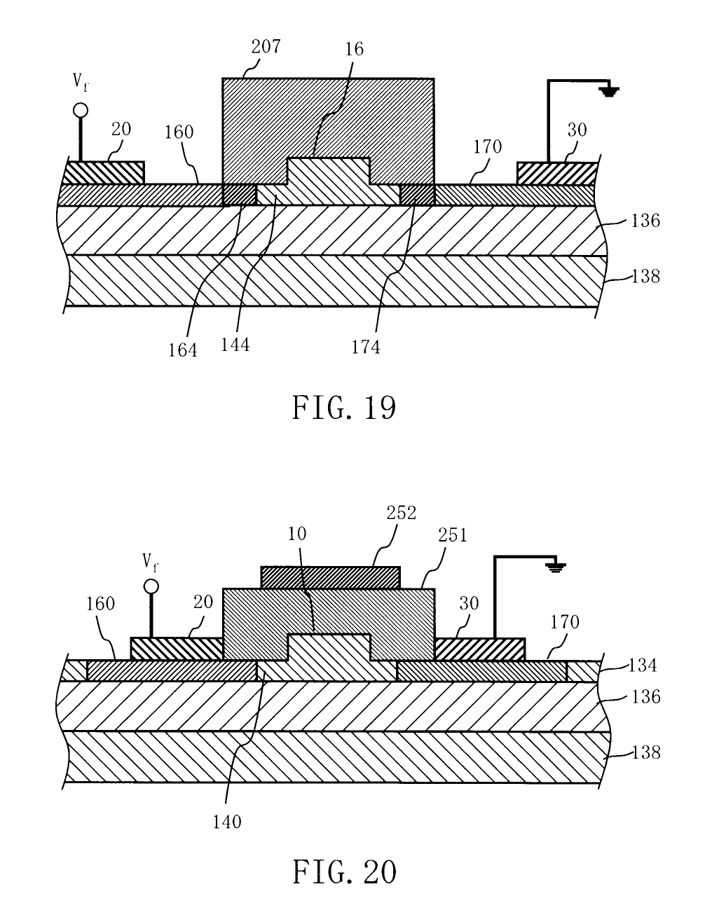

In FIG. 19, a sectional view showing an example of the configuration of a ring resonator portion of the ring optical modulator according to a third embodiment is shown. Because the resonant wavelength is extremely sensitive to the temperature, it is more desirable to make the ring resonator athermal, which practically eliminates temperature dependency. For this purpose, an optical modulator is made athermal by using a material of which the temperature coefficient of the refractive index dn/dT is negative is used for at least a portion of the cladding part of the optical waveguide constituting the ring resonator. Examples of the material with a negative dn/dT include titanium oxide (TiO₂), SiₓTi₍₁₋ₓ₎O_{y}, polymers, and polyimides. Here, the optical waveguide portion is covered with the TiO₂ film 207 (upper cladding part) having the width 700 nm and the thickness 500 nm. The lower cladding is the 3-μm thick SiO₂ layer 136 (the BOX layer of the SOI substrate). Points not specifically mentioned below are the same as in the first embodiment.

Generally, a material with a negative dn/dT has a refractive index lower than that of Si and thus, it is effective to ooze out a considerable ratio of optical mode into the cladding material with negative dn/dT by reducing the cross section of the Si waveguide to make the waveguide athermal. In the example in FIG. 19, the cross section of the Si waveguide is reduced by making the width of a mesa portion 16 smaller than in each of the above embodiments. Here, the mesa portion 16 is formed to a width of 200 nm. The thickness of the mesa portion 16 is 90 nm and the remaining slab portion is formed to a thickness of 50 nm.

The semiconductor region 160 of p type is formed in a position on the side of one sidewall a predetermined distance away from the mesa portion 16 and the semiconductor region 170 of n type is formed in a position on the side of the other sidewall a predetermined distance away therefrom in a slab portion of the top Si layer of the SOI substrate, which is the same as in the first embodiment described above. In the third embodiment, however, the circular loss is not controlled by the distance between the mesa portion 16 and the p type semiconductor region 160 or the n type semiconductor region 170. Thus, the mesa portion 16 and the p type semiconductor region 160 or the n type semiconductor region 170 may be arranged away from each other so that no circular loss arises. In view of tradeoffs of resistance reduction and optical loss suppression, a (p−) type semiconductor region 164 whose carrier density is lower than that of the (p+) type semiconductor region 160 may be formed between the (p+) type semiconductor region 160 and an i-Si region 144. Similarly, an (n−) type semiconductor region 174 whose carrier density is lower than that of the (n+) type semiconductor region 170 may be formed between the (n+) type semiconductor region 170 and the i-Si region 144. In FIG. 19, the TiO₂ film 207 is formed on the i-Si region 144 including the mesa portion 16 and the (p−) type semiconductor region 164 and the (n−) type semiconductor region 174 on both sides thereof. The ohmic contact 20 is formed on the (p+) type semiconductor region 160 and the ohmic contact 30 is formed on the (n+) type semiconductor region 170, which is the same as in the first embodiment.

To suppress an increase in radiation loss in an optical waveguide whose cross section is small and whose optical confinement is weak, it is necessary to considerably increase the minimum radius of the ring resonator and if an attempt is made to make the optical waveguide athermal according to a conventional method, problems are posed from the viewpoint of the high speed and footprint. The refractive index of TiO₂ and the temperature coefficient dn/dT thereof take various values depending on the production method and the refractive index of the TiO₂ film 207 used here near the wavelength 1550 nm is about 2.3 and dn/dT is −1×10⁻⁴/K. Because the negative temperature coefficient of the TiO₂ film 207 cancels out the positive temperature coefficient of the Si layer including the mesa portion 16 and the SiO₂ layer 136, the waveguide almost satisfies the athermal conditions for propagation light of TE fundamental mode (effective refractive index: 2.06). However, a considerable ratio of guided light is oozed into the TiO₂ film 207 (upper cladding part), posing a problem that the radiation loss cannot be ignored unless the bending radius is set to 10 μm or more, and in addition, a high-speed operation cannot be realized. According to the present embodiment, however, a circular loss should be increased on purpose and thus, the minimum radius of the resonator can be set a little smaller. The circular loss of the resonator can be adjusted to a range in which conditions of Formulae (2) to (8) are satisfied by adjusting the minimum radius of the resonator and therefore, an athermal optical modulator that is small, fast, and practical can be realized. Conditions of Formulae (2) to (8) can be satisfied by a relatively small athermal optical modulator whose radius is around 8 μm so that a fast operation of 5 Gbps or more can be realized.

Here, while the circular loss should be eliminated by decreasing the cross section of the mesa portion and, for that, by increasing the minimum radius of the resonator, the circular loss is adjusted to a range in which conditions of Formulae (2) to (8) are satisfied by making the minimum radius of the resonator a little smaller.

Even in a non-athermal ring resonator, the circular loss of the resonator can be increased by making the cross section of the Si mesa portion of the optical waveguide constituting the ring resonator smaller than the cross section of the mesa portion of a principal portion (low-loss optical waveguide portion away from the ring optical modulator) of the input/output optical waveguide. Therefore, adjustments to a range in which conditions of Formulae (2) to (8) are satisfied may suitably be made by the above method.

### Fourth Embodiment

The method of controlling the circular loss is not limited to the above embodiments. In the fourth embodiment, a configuration in which the resonant wavelength is fine-tuned by controlling the temperature using a micro-heater will be described. In the ring resonator, as described above, the resonant wavelength is extremely sensitive to the temperature. Thus, in the fourth embodiment, the temperature is controlled by arranging a micro-heater near the optical waveguide on purpose. Points not specifically mentioned below are the same as in the first embodiment.

In FIG. 20, a sectional view showing an example of the configuration of the ring resonator portion of the ring optical modulator according to a fourth embodiment is shown. A micro-heater 252 is arranged above the mesa portion 10 of the optical waveguide constituting the ring resonator. The resonant wavelength can be fine-tuned by supplying current to the micro-heater 252. For example, a metallic resistance film of tungsten, nickel or the like can suitably be used as a material of the micro-heater 252. Among configurations shown in FIGS. 1 to 3, the distance from the mesa portion 10 to the p type semiconductor region 160 and the distance from the mesa portion 10 to the n type semiconductor region 170 are set to 400 nm, which does not cause any circular loss. The i-Si region 140 including the mesa portion 10 is covered with a silicon oxide film 251 to constitute an upper cladding part. Then, the micro-heater 252 is formed on the silicon oxide film 251. The distance between the upper part of the mesa portion 10 and the micro-heater 252 is set to about 300 nm.

In the above configuration, the guided wave loss of the ring resonator is larger than that of a ring resonator without micro-heater by 15 dB/cm. As a result, the circular loss of the resonator is approximately the same as in the first embodiment, enabling fast modulation without pre-emphasis. In a conventional tunable ring resonator, a larger distance is required between the micro-heater and the mesa portion of the optical waveguide so that no circular loss is generated. In the fourth embodiment, by contrast, the circular loss is increased on purpose by bringing the micro-heater 252 and the mesa portion 10 of the optical waveguide closer to each other. Therefore, compared with a case when designed according to the conventional method, the resonant wavelength can be controlled faster with a smaller current.

Instead of arranging the micro-heater 252 on the upper part of the mesa portion 10, the ohmic electrodes 20, made of metal or silicide may suitably be brought closer to positions within 500 nm from the optical waveguide. In this case, an effect of miniaturization of elements and lower resistance is also achieved.

### Fifth Embodiment

In each of the above embodiments, the optical waveguide is constituted by using a single crystal top Si layer of the SOI substrate, but the embodiments are not limited to the above examples. In the fifth embodiment, a configuration in which the circular loss of the resonator is adjusted by including a polysilicon layer in a portion of the optical waveguide will be described. Points not specifically mentioned below are the same as in the first embodiment.

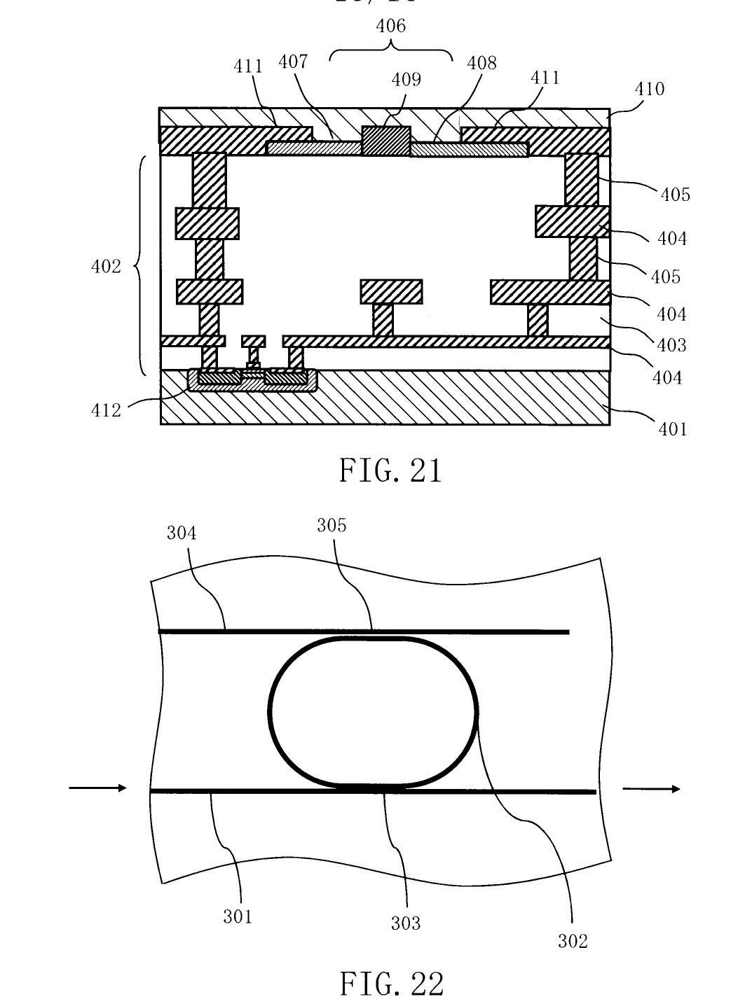

In FIG. 21, a sectional view showing an example of the configuration of a semiconductor device mounted with the ring optical modulator according to a fifth embodiment is shown. In FIG. 21, the ring optical modulator according to the fifth embodiment constitutes a portion of an optical integrated circuit for optical wiring formed on a multilayer metal wiring layer 402 of a CMOS integrated circuit formed on a Si substrate 401. If polysilicon is used for a portion of the optical waveguide constituting the ring resonator, the circular loss of the resonator can be increased due to a scattering loss caused by a grain boundary of the polysilicon. This method is particularly useful, as shown in FIG. 21, when the optical integrated circuit is formed on electric wiring layers of LSI by a back-end process. The electric wiring layers 402 formed by a normal backend process is composed of a multi-level metal wiring layers 404 embedded in a dielectric film 403 and a metal via 405 connecting the metal wiring layers 404. Though an actual LSI has more metal layers, only three metal layers are shown in FIG. 21 to simplify the explanation.

A closed loop optical waveguide 406 of the ring optical modulator in the present embodiment includes a low-temperature formed p-type polysilicon layer 407, a low-temperature formed n-type polysilicon layer 408, and a hydrogen-terminated undoped amorphous silicon (a-Si:H) mesa portion 409 formed by low-temperature (up to 250° C.) plasma CVD so as to be in contact with the polysilicon layers 407, 408. The closed loop optical waveguide 406 of the ring optical modulator is formed on the dielectric film 403 in which the electric wiring layers are embedded. Then, these layers are embedded in a dielectric film 410 almost flatly from above. The thickness of the polysilicon layers 407, 408 formed in a slab portion of the closed loop optical waveguide 406 is 50 nm and the thickness of the a-Si:H mesa portion 409 is about 220 nm and the width thereof is about 450 nm. The polysilicon layers 407, 408 are connected to a CMOS drive circuit 412 via a metal wire 411, the via 405 and the metal wiring layers 404.

It is assumed here that the radius of the ring resonator is 10 μm and the length and gap of the directional coupler are 5 μm and 370 nm respectively. In portions excluding the directional coupler of the input/output waveguide, an a-Si:H photonic wire waveguide without polysilicon slab is provided. The optical loss of the a-Si:H mesa portion 409 itself is small and the transmission loss of the input/output optical waveguide becomes 2 dB/cm or less. On the other hand, the circular loss is about 4.5% (equivalent to about 30 dB/cm) because the ring resonator has the scattering loss by the grain boundary of the polysilicon layers 407, 408 of the polysilicon slab, free carrier absorption, radiation loss, mode conversion loss and the like. The power coupling ratio of the directional coupler is about 5%. Though the series resistance is a little high, a-Si:H has a shorter carrier lifetime than that in the crystal Si and thus, the response time of carriers becomes shorter than that in the first embodiment. As is evident from FIG. 14A, the above ring resonator satisfies conditions of Formulae (2) to (8). Because the carrier lifetime is short, optical transmission at 10 Gbps or more becomes possible if a drive circuit can be made faster. The ring resonator and the drive circuit are proximity-integrated and thus, a matching resistance is not needed and power consumption for 5-Gbps transmission is 0.3 mW.

According to the fifth embodiment, as described above, the circular loss can be adjusted by using polysilicon whose optical loss is a bit large for a portion of the optical waveguide. Even if polysilicon is used for a portion of the optical waveguide, a ring optical modulator with excellent characteristics can be realized, which is extremely effective when optical integrated circuits are integrated onto an LSI chip by the back-end process.

### Sixth Embodiment

In each of the above embodiments, a ring resonator and one input/output optical waveguide 110 are included, but the embodiments are not limited to the above example. In the sixth embodiment, a configuration in which a plurality of input/output optical waveguides is connected to the ring resonator will be described. Points not specifically mentioned below are the same as in the first embodiment.

In FIG. 22, a conceptual diagram of a top surface showing the configuration of the ring optical modulator according to a sixth embodiment is shown. In FIG. 22, only the optical waveguide portion is shown to make an understanding of content easier. An illustration of the other configuration is omitted. An input/output optical waveguide 301 (first input/output optical waveguide) is optically coupled to a closed loop optical waveguide 302 in a racetrack shape via an optical coupler 303 (first optical coupler). Up to now, the configuration is the same as the configuration of the ring optical modulator in FIG. 1. In FIG. 22, an input/output optical waveguide 304 (second input/output optical waveguide) (drop port) arranged in a position different from the position of the input/output optical waveguide 301 so that a portion thereof is positioned near a portion of the closed loop optical waveguide 302 is further included. The input/output optical waveguide 304 is optically coupled to the closed loop optical waveguide 302 via an optical coupler 305 (second optical coupler).

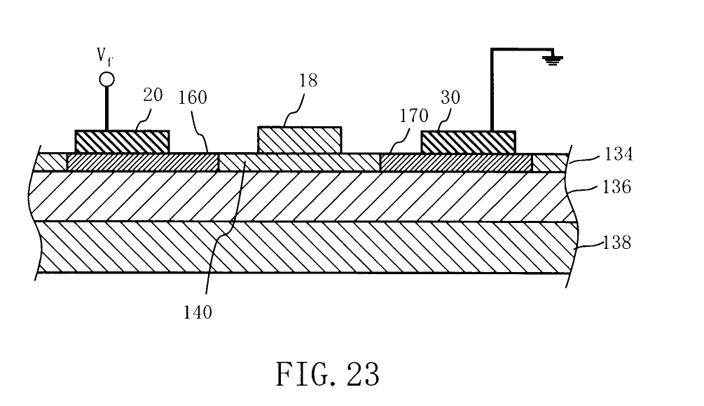

In FIG. 23, a sectional view of the ring resonator portion of the ring optical modulator according to the sixth embodiment is shown. In FIG. 23, the optical waveguide of the ring resonator is constituted of a crystal Si slab 134 whose thickness is 50 nm and a mesa portion 18 (thickness: 170 nm, width: 450 nm) composed of amorphous silicon (a-Si:H) formed thereon. Excluding the above points, the configuration is the same as the configuration in FIG. 1. However, in the ring resonator shown in FIG. 23, the circular loss is not adjusted by adjusting the distance from the sidewall of the mesa portion 18 to the p type semiconductor region 160 and the distance from the sidewall of the mesa portion 18 to the n type semiconductor region 170. Thus, the distance from the sidewall of the mesa portion 18 to the p type semiconductor region 160 and the distance from the sidewall of the mesa portion 18 to the n type semiconductor region 170 may each be set to a distance that does not cause a circular loss. The closed loop optical waveguide 302 in a racetrack shape is composed of an arc-shaped waveguide portion whose radius is 10 μm and linear optical coupler 303, 305 (length: 2.5 μm) portions (circumference: about 67.8 μm). The guided wave loss of the resonator itself is about 10 dB/cm (equivalent to the circular loss 1.6%) and a non-symmetrical structure in which the gap between optical waveguides in the first optical coupler 303 is 330 nm (power coupling ratio: 4.4%) and the gap between optical waveguides in the second optical coupler 305 is 380 nm (power coupling ratio: 2.2%) is adopted. The second optical coupler 304 does not interfere with input light and thus, optical power branched into the drop port via the second optical coupler 305 becomes a portion of the loss of the resonator. Thus, the circular loss of the resonator becomes 3.8% even if another loss is not intentionally provided to the waveguide constituting the resonator so that conditions corresponding to Formulae (2) to (8) can be satisfied. Therefore, excellent optical transmission at 10 Gbps can be realized by using a through-port side optical output under the same drive conditions as in the first embodiment. Optical output of the second optical coupler 304 can be used for monitoring of resonant conditions of the resonator or complementary optical transmission. In order to obtain the best characteristics, it is preferable to set the power coupling ratio of the second optical coupler 305 smaller than the power coupling ratio of the first optical coupler 303.

If a two-output ring optical modulator is used, the drop port can be used for monitoring of the resonant wavelength and thus, the resonant wavelength can be fitted to the wavelength of a light source by combining with a micro-heater provided in proximity to the control circuit and ring resonator. This is useful when the wavelength of a light source fluctuates due to a temperature change or the like or wavelength channels of the optical modulators are used in WDM by switching the channels.

Moreover, through-port output and complementary output from the drop port can be obtained and if combined with a differential optical receiver, signal transmission can be performed with a smaller extinction ratio or smaller optical power compared with single-end transmission. A larger insertion loss occurs and the rise is more delayed on the drop-port side than on the through-port side and thus, it is difficult to satisfy the above eye criteria of (1) to (3) at 10 Gbps unless the carrier lifetime is shortened. In the present embodiment, the carrier lifetime of a-Si:H is shorter than when the top crystalline Si layer of the SOI substrate is used and so the drop-port side responds at high speed and complementary optical transmission at 10 Gbps can be performed.

In the foregoing, embodiments have been described with reference to concrete examples. However, the embodiments are not limited to such concrete examples. For example, adjustments may suitably be made to satisfy conditional expressions by introducing impurities or defects to shorten the carrier lifetime into at least a portion of the optical waveguide constituting the ring resonator. A faster response can be realized by doping the optical waveguide with a metal impurity such as gold and platinum or introducing defects through ion implantation of silicon, hydrogen, helium or the like. While it is widely known that the carrier response can be made faster by the above method, the present embodiment is characterized in that conditions of Formulae (2) to (8) are satisfied as a result of an increased circular loss of the resonator due to metal impurities or defects. Each of the above embodiments may appropriately be combined. The power coupling ratio of the directional coupler can be controlled by, in addition to the gap between waveguides and length of the directional coupler, the slab layer thickness and selection of the upper cladding part material.

As the wavelength moves away from the 1.55 μm band, the optimal range deviates from a range defined by Formulae (2) to (5), but the optimal point is within the range defined by Formulae (2) to (8).

The power coupling ratio of the directional coupler can be determined from a power branching ratio of the directional coupler for evaluation produced by the same process. Alternatively, if dimensions of the directional coupler and the refractive indexes of components are known, the power coupling ratio can be calculated by a simulation based on BPM, FDTD or the like. Since coupling of light in the curved input and output portions of the directional coupler cannot be ignored, calculation based on the coupled-mode theory, in which only the linear waveguide portion of the coupler is taken into account, is insufficient.

Though the circular loss of a resonator is not a quantity that can be determined directly from the characteristic evaluation of a single ring optical modulator, the circular loss can be determined from transmission characteristics of a plurality of optical waveguides for evaluation in which the length, number of bending, number of connections of a linear waveguide and curved waveguide and the like. Alternatively, the circular loss can be estimated by comparing the contrast ratio or spectral bandwidth of output spectra of a plurality of ring optical resonators having the same circumference and different power coupling ratios of the directional couplers with theoretical calculation. If the circular loss is a little smaller than the power coupling ratio, the circular loss of the resonator=the power coupling ratio (critical coupling) of the directional coupler holds in a position where the current is injected and the contrast of the transmission spectrum is deepest. If the power coupling ratio of the directional coupler and the carrier lifetime are known, the circular loss when no voltage is applied can be calculated by using these values.

According to each embodiment, as has been described in detail, fast optical modulation can be performed by being driven at a low voltage without applying pre-emphasis. In any case, it is necessary to satisfy conditions of Formulae (2) to (8). Care must be taken so that the series resistance or parasitic capacitance of elements should not increase due to the adoption of the above configuration.

Concerning the thickness, size, shape, number and the like of each layer (film), we can choose various values according to the requirements of individual application.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalents are intended to cover such forms or modifications as would fall within the scope and spirit of the inventions.

While techniques normally used in the semiconductor industry such as a photolithography process and cleaning before and after treatments are not described for convenience of description, it is needless to say that such techniques are included in the scope of the present embodiments.

What is claimed is:

1. A ring optical modulator comprising:
a ring resonator configured to have a closed loop optical waveguide in a p-i-n diode structure including a current injection portion injecting a current; and
an input/output optical waveguide configured to input and output a light, and to be arranged in such a way that a portion thereof is positioned close to a portion of the closed loop optical waveguide,
wherein the portion of the closed loop optical waveguide and the portion of the input/output optical waveguide positioned close to each other function as an optical coupler optically coupling the ring resonator and the input/output optical waveguide in the ring optical modulator, intensity of light of a resonant wavelength λᵣ input from one end of the input/output optical waveguide and intensities of wavelengths in a predetermined range from the resonant wavelength are modulated by changing a current injected into the ring resonator to change the resonant wavelength λᵣ via a carrier density and an effective refractive index in the closed loop optical waveguide, and
relationships of Formula (2) to Formula (8), using a group index n_{g} of refraction at the resonant wavelength λᵣ of the closed loop optical waveguide constituting the ring resonator, a circumference l [μm] of the closed loop optical waveguide, and a waveguide length l′ [μm] of a remaining portion of the closed loop optical waveguide excluding the portion of the ring resonator functioning as the optical coupler, are satisfied by a loss x [%] per revolution of the resonator for the light of the resonant wavelength λᵣ revolving around the ring resonator from output to input of the optical coupler when the current is turned off and a power coupling ratio y [%] of the optical coupler for the light of the resonant wavelength λᵣ.
$$\begin{matrix}x \geq \{ \begin{matrix}\frac{1}{{a}_{1}^{2}} {( y - {y}_{1} )}^{2} + {x}_{1} & ( y \geq {y}_{1} ) \\ {x}_{1 } & ( y < {y}_{1} )\end{matrix} & ( 2 ) \\ y \geq \{ \begin{matrix}{{a}_{2} ( x - {x}_{2} )}^{2} + {y}_{2} & ( x \geq {x}_{2} ) \\ {y}_{2} & ( x < {x}_{2} )\end{matrix} & ( 3 ) \\ x \leq \{ \begin{matrix}{x}_{ma x} & ( y \leq {y}_{ma x} - 0.8 ) \\ {x}_{ma x} - ( y - {y}_{ma x} + 0.8 ) & ( y > {y}_{ma x} - 0.8 )\end{matrix} & ( 4 ) \\ y \leq {y}_{ma x} & ( 5 ) \\ {a}_{1} = 0.0034 {n}_{g} l + 2.96 \\ {x}_{1} = 0.0088 {n}_{g} l - 0.25 \\ {y}_{1} = 0.0118 {n}_{g} l - 1.45 & ( 6 ) \\ {a}_{2} = 0.27 \\ {x}_{2} = 0.0167 {n}_{g} l - 0.84 \\ {y}_{2} = 0.0091 {n}_{g} l & ( 7 ) \\ {x}_{ma x} = 0.0192 {n}_{g} {l}^{′} + 0.15 \\ {y}_{ma x} = 0.0211 {n}_{g} {l}^{′} + 0.58 & ( 8 )\end{matrix}$$

2. The ring optical modulator according to claim 1, wherein relationships of Formula (9) and Formula (10) are further satisfied by the loss x [%] per revolution of the resonator and the power coupling ratio y [%] of the optical coupler.
(x−x₀)²+(y−y₀)²≦0.25² (9)
x₀=0.0135n_{g}l′+0.09
y₀=0.0152n_{g}l′+0.17 (10)

3. The ring optical modulator according to claim 1, wherein a rib optical waveguide having a mesa portion and a slab portion using silicon (Si) as a main component is used as the closed loop optical waveguide constituting the ring resonator.

4. The ring optical modulator according to claim 3, wherein the rib optical waveguide constituting the ring resonator has slab portions on both sides of the mesa portion, one of the slab portions is provided with a p type impurity doped region whose carrier density is 5×10¹⁹ cm⁻³ or more, another of the slab portions is provided with an n type impurity doped region whose carrier density is 5×10¹⁹ cm⁻³ or more, and the p type impurity doped region and the n type impurity doped region are formed so that a distance of a shortest from a sidewall of the mesa portion on a side of the p type impurity doped region to an end of the p type impurity doped region and a distance of a shortest from a sidewall of the mesa portion on a side of the n type impurity doped region to an end of the n type impurity doped region are both between 100 and 180 nm.

5. The ring optical modulator according to claim 3, wherein a rib optical waveguide having a mesa portion and a slab portion using silicon (Si) as a main component is used as the input/output optical waveguide,
wherein the mesa portion of the closed loop optical waveguide has a cross section formed narrower than the cross section of the mesa portion of the input/output optical waveguide.

6. The ring optical modulator according to claim 3, further comprising at least one of a metal and a metal silicide in a position within 500 nm from the mesa portion of the closed loop optical waveguide.

7. The ring optical modulator according to claim 3, further comprising a heater in a position within 500 nm from the mesa portion of the closed loop optical waveguide.

8. The ring optical modulator according to claim 7, wherein the resonant wavelength of the closed loop optical waveguide is controlled by passing a current to the heater.

9. The ring optical modulator according to claim 1, wherein a product of a series resistance at the higher voltage state (V=V_{H}) of the modulation of the p-i-n diode structure and a circumference of the ring resonator is 4 Ωmm or less.

10. The ring optical modulator according to claim 9, wherein a rib optical waveguide constituting the ring resonator has a mesa portion and slab portions on both sides of the mesa portion is used as the closed loop optical waveguide constituting the ring resonator, one of the slab portions is provided with a p type impurity doped region whose carrier density is 5×10¹⁹ cm⁻³ or more, another one of the slab portions is provided with an n type impurity doped region whose carrier density is 5×10¹⁹ cm⁻³ or more, and
the p type impurity doped region and the n type impurity doped region are formed so that a distance of a shortest from a sidewall of the mesa portion on a side of the p type impurity doped region to an end of the p type impurity doped region and a distance of a shortest from a sidewall of the mesa portion on the side of the n type impurity doped region to an end of the n type impurity doped region are both between 100 and 180 nm.

11. The ring optical modulator according to claim 9, wherein a rib optical waveguide having a mesa portion and a slab portion using silicon (Si) as a main component is used as the closed loop optical waveguide,
wherein a rib optical waveguide having a mesa portion and a slab portion using silicon (Si) as a main component is used as the input/output optical waveguide,
wherein the mesa portion of the closed loop optical waveguide has a cross section formed narrower than the cross section of the mesa portion of the input/output optical waveguide.

12. The ring optical modulator according to claim 11, further comprising at least one of a metal and a metal silicide in a position within 500 nm from the mesa portion of the closed loop optical waveguide.

13. The ring optical modulator according to claim 11, further comprising a heater in a position within 500 nm from the mesa portion of the closed loop optical waveguide.

14. The ring optical modulator according to claim 13, wherein the resonant wavelength of the closed loop optical waveguide is controlled by passing a current to the heater.

15. The ring optical modulator according to claim 1, wherein the closed loop optical waveguide has a portion whose curvature radius is 5 to 7.5 μm.

16. The ring optical modulator according to claim 1, wherein the closed loop optical waveguide has a plurality of curved portions and one of the plurality of curved portions has a curvature radius smaller than the curvature radius of another one of the plurality of curved portions.

17. The ring optical modulator according to claim 1, further comprising a cladding part covering at least a portion of the closed loop optical waveguide and using a material a temperature coefficient of a refractive index of which is negative.

18. The ring optical modulator according to claim 1, wherein polysilicon is used as a material for a portion of the closed loop optical waveguide.

19. The ring optical modulator according to claim 1, wherein the input/output optical waveguide is defined as a first input/output optical waveguide and the optical coupler is defined as a first optical coupler,
further comprising a second input/output optical waveguide configured to be arranged in an another position different from the position of the first input/output optical waveguide so that a portion thereof is positioned near an another portion of the closed loop optical waveguide,
wherein the another portion of the closed loop optical waveguide and the portion of the second input/output optical waveguide positioned close to each other function as a second optical coupler optically coupling the ring resonator and the second input/output optical waveguide and the relationships of the Formula (2) to Formula (8) are satisfied by a loss x [%] per revolution of the resonator including a coupling loss to the second input/output optical waveguide and a power coupling ratio y [%] of the first optical coupler.

20. The ring optical modulator according to claim 19, wherein the ring optical modulator is formed so that the power coupling ratio of the second optical coupler is smaller than the power coupling ratio of the first optical coupler.
